(19) United States
(12) Patent Application Publication
(10) Pub. No.: US 2004/0263716 A1
(43) Pub. Date: Dec. 30, 2004

(54) Liquid crystal display apparatus

(76) Inventors: Sang-Duk Lee, Gyeonggi-do (KR); Yoon-Soo Kwon, Gyeonggi-do (KR)

Correspondence Address: CANTOR COLBURN, LLP, 55 GRIFFIN ROAD SOUTH, BLOOMFIELD, CT, 06002

(21) Appl. No.: 10/494,623

(22) PCT Filed: Mar. 4, 2002
(86) PCT No.: PCT/KR02/00364

(30) Foreign Application Priority Data
Nov. 13, 2001 (KR) 2001/70568

(51) Int. Cl. G02F 1/1335

(52) U.S. Cl. 349/61

(57) ABSTRACT

Disclosed is an LCD apparatus for reducing a whole size thereof. The LCD apparatus includes a lamp unit (700), a light guiding unit (800) having a projecting surface, a reflecting surface, and a side surface, and a receiving unit having a sidewall and a bottom prolonged from the sidewall. The lamp unit (700) is disposed between the side surface of the light guiding unit (800) and the sidewall of the receiving unit so that the side surface is surrounded by means of the lamp unit (700). The size of the LCD device can be reduced, and a thickness increase of the LCD apparatus may be prevented while obtaining an enough amount of the light to display an image. Further, the light is uniformly distributed over the whole surface of the light guiding unit (800), and it can prevent the parts of the circuits of the display unit (200) from being damaged.

### TECHNICAL FIELD

The present invention relates to a liquid crystal display apparatus, and more particularly to a liquid crystal display apparatus having a reduced whole size.

### BACKGROUND ART

In general, in order to confirm the information processed in an information-processing device with the naked eye, a display apparatus which accomplishes an interface function is needed. Recently, a liquid crystal display device which is lighter, and smaller than a CRT type display apparatus has been developed. The liquid crystal display device has a function such as a full color and a high resolution. As a result, the liquid crystal display device is widely used as a monitor of a computer, a television receiver, and another display device.

FIG. 1 is a sectional view showing a combination construction of a conventional liquid crystal display apparatus.

As shown in FIG. 1, a first lamp unit 16 and a second lamp unit 18 are received at both ends of a receiving space of a mold frame 10, respectively. A first lamp cover 12 is disposed between the first lamp unit 16 and the mold frame 10 to cover the first lamp unit 16, and a second lamp cover 14 is disposed between the second lamp unit 18 and the mold frame 10 to cover the second lamp unit 18. The first and second lamp covers 12 and 14 reflect a light emitted from the first and second lamp unit 16 and 18, respectively. A light guiding plate 22 is provided between the first lamp unit 16 and the second lamp unit 18 and guides the light from the first and second lamp units 16 and 18 to emit the light in an upper direction of the light guiding plate 22.

Further, a reflecting plate 20 is disposed under the light guiding plate 22 so as to reflect the light leaked from the light guiding plate 22, and an optical sheet 26 is installed on the light guiding plate 22 so as to control brightness characteristics of the light radiated from the light guiding plate 22. Also, a display unit 28 that receives the light provided from the light guiding plate 22 and displays an image is installed on the optical sheet 26.

In the meantime, the mold frame 10 generally made of metal material is received in a bottom chassis 24, and then a top chassis 30 having a bottom which is partially opened to expose an effective display area of the display unit 28 is combined with the bottom chassis 24 so that the display unit 28 is fixed to the mold frame 10.

In the liquid crystal display apparatus which displays the image using the light generated from the lamp, when the effective display area becomes large, an amount of the light required to display the image through the display unit 28 increases. That is, in order to uniformly maintain the brightness distribution of the light provided from the first and second lamp units 16 and 18 to the display unit 28 through the light guiding plate 22 regardless of the effective display area of the image, the amount of the light have to be increased in proportion as an increase of the size of the liquid crystal display apparatus. For this purpose, as shown in FIG. 1, the liquid crystal display apparatus which adopts a plurality of lamps is widely used.

However, if the number of lamps of the first and second lamp units 16 and 18 installed at a side portion of the light guiding plate 22 increases to obtain the amount of the light which is enough to display the image, the whole thickness T1 of the liquid crystal display apparatus becomes thicker.

Besides, since the lamps of the first and second lamp units 16 and 18 are closely installed in opposite ends of the light guiding plate 22, heat generated from the lamps is concentrated in regions adjacent to the first and second lamp units 16 and 18. So, parts of the circuits of the display unit 28 adjacent to the first and second lamp units 16 and 18 may be damaged.

### DISCLOSURE OF INVENTION

Accordingly, it is a first object of the present invention to provide a backlight assembly capable of reducing a whole size thereof.

It is a second object of the present invention to provide a liquid crystal display apparatus capable of minimizing of a whole size thereof.

To accomplish the first object, there is provided a backlight assembly including a lamp unit for generating a light, a light guiding unit having a projecting portion for projecting the light, a reflecting portion for reflecting the light to the projecting portion and a side portion which connects the projecting portion with the reflecting portion and receives the light, for guiding the light, and a receiving unit having a sidewall and a bottom prolonged from the sidewall, for receiving the lamp unit and the light guiding unit. At this time, the lamp unit is disposed between the side portion of the light guiding unit and the sidewall of the receiving unit so as to cover the side portion of the light guiding unit.

The receiving unit further includes protruding portions respectively formed at corners of the bottom of the receiving unit and the light guiding unit further includes clamping portions formed in the light guiding unit by cutting off the light guiding unit. The protruding portions prevent the lamp unit from being deviated from the receiving unit and the protruding portions are combined with the clamping portions so as to prevent the light guiding unit from being moved toward the lamp unit.

The lamp unit includes a first lamp having a L shape by integrally forming a first and a second light generating portion and a second lamp having the L shape by integrally forming a third and a fourth light generating portion. The first light generating portion covers a first side portion of the light guiding unit, the second light generating portion covers a second side portion adjacent to the first portion, the third light generating portion covers a third side portion facing to the first side portion and the fourth light generating portion covers a fourth side portion facing to the second side portion and adjacent to the third side portion.

To accomplish the second of the present invention, there is a liquid crystal display apparatus including a lamp unit for generating a light, a light guiding plate having a projecting portion for projecting the light, a reflecting portion for reflecting the light to the projecting portion and a side portion which connects the projecting portion with the reflecting portion and receives the light, for guiding the light, a mold frame having a sidewall of which a central portion is opened by a predetermined size and a bottom prolonged from the sidewall, for receiving the lamp unit and the light guiding unit, a reflecting sheet disposed under the light guiding plate and having at least one first guide hole formed at one end, for reflecting the light leaked from the light guiding plate, a bottom chassis having at least one second guide hole and combined with the mold frame so as to prevent the lamp unit, the light guiding plate and the reflecting sheet from being deviated from the mold frame, an optical sheet disposed on the light guiding plate, for adjusting brightness of the light emitted from the light guiding plate, a display unit disposed on the optical sheet, for receiving the light from the optical sheet and displaying an image, and a top chassis combined with the bottom chassis so as to fix the display unit to the mold frame. At this time, the lamp unit is disposed between the light guiding plate and the sidewall of the mold frame so as to cover the side portion of the light guiding plate.

According to the liquid crystal display apparatus, the lamp unit having two L-shaped lamps or one square-shaped lamp is disposed between the light guiding plate and the mold frame so that the four side portions of the light guiding plate are surrounded by means of the lamp. Therefore, it is able to reduce the whole thickness of the liquid crystal display apparatus and it is able to easily discharge the heat generated from the lamp unit, thereby preventing the parts of the circuits of the display unit from being damaged.

### BRIEF DESCRIPTION OF DRAWINGS

The above objects and other advantages of the present invention will become more apparently by describing in detail the preferred embodiments thereof with reference to the accompanying drawings, in which:

FIG. 1 is a sectional view showing an assembled structure of a conventional liquid crystal display apparatus;

FIG. 2 is a disassembled perspective view of a liquid crystal display apparatus in accordance with a first preferred embodiment of the present invention;

FIG. 3 is a plan view showing a structure of the mold frame shown in FIG. 2 in detail;

FIG. 4 is a sectional view showing a structure of a sidewall of the mold frame shown in FIG. 3;

FIG. 5 is a perspective view showing a structure of the lamp cover shown in FIG. 5;

FIG. 6 is a perspective view showing a structure of the light guiding plate shown in FIG. 6;

FIGS. 7 to 10 are views showing a structure of the lamp shown in FIG. 2;

FIG. 11 is a plan view showing a structure of the optical sheet part shown in FIG. 2;

FIG. 12 is a plan view showing a structure of the reflecting plate shown in FIG. 2;

FIG. 13 is a plan view showing an assembled structure between the lamp cover and the mold frame shown in FIG. 2;

FIG. 14 is a sectional view taken along the line B-B′ in FIG. 13 for showing an assembled structure between the mold frame and the lamp cover;

FIGS. 15 and 16 are partially cut perspective views showing a structure of a third stopper shown in FIG. 3;

FIG. 17 is a plan view showing an assembled structure between the lamp part and the mold frame shown in FIG. 13;

FIG. 18 is a sectional view taken along the line C-C′ in FIG. 17 for showing an assembled structure between the mold frame, the lamp cover and the lamp part;

FIG. 19 is a partially cut perspective view showing an assembled structure between the first and third lamp covers received in the second stopper side and the second and fifth lamp holders in detail;

FIGS. 20 to 23 is a partially cut perspective view showing a withdrawn structure of power supply lines of the lamp part shown in FIG. 2;

FIG. 24 is a plan view showing an assembled structure between the light guiding plate and the mold frame shown in FIG. 17;

FIG. 25 is a plan view showing an assembled structure between the light guiding plate and the reflecting plate shown in FIG. 24;

FIG. 26 is a sectional view taken along the line D-D′ for showing an assembled structure between the light guiding plate and the reflecting plate shown in FIG. 25;

FIG. 27 is a plan view showing a structure of the bottom chassis shown in FIG. 2;

FIG. 28 is a plan view showing an assembled structure between the optical sheet part and the mold frame shown in FIG. 25;

FIG. 29 is a plan view showing a fixed structure between the mold frame and the optical sheet shown in FIG. 29;

FIG. 30 is a sectional view taken along the line E-E′ for showing the liquid crystal display apparatus shown in FIG. 29;

FIG. 31 is a plan view showing a structure of the top chassis shown in FIG. 31;

FIG. 32 is a sectional view showing an assembled structure between the bottom chassis which receives the mold frame and the top chassis;

FIG. 33 is a plan view showing a structure of a mold frame in accordance with a second preferred embodiment of the present invention;

FIG. 34 is a plan view showing a structure of a rear surface of the mold frame shown in FIG. 33;

FIG. 35 is a plan view showing a structure of an optical sheet part according to the second preferred embodiment of the present invention;

FIG. 36 is a plan view showing an assembled structure between the optical sheet part shown in FIG. 35 and the mold frame shown in FIG. 33;

FIG. 37 is a perspective view showing a structure of a lamp according to a third preferred embodiment of the present invention;

FIGS. 38 and 39 are plan views showing an assembled structure between the mold frame according to the third embodiment of the present invention and the lamp shown in FIG. 37;

FIG. 40 is a sectional view showing an assembled structure of the liquid crystal display apparatus according to the third embodiment of the present invention; and

FIGS. 41 and 42 are views showing a structure of first to sixth guide holes shown in FIG. 27.

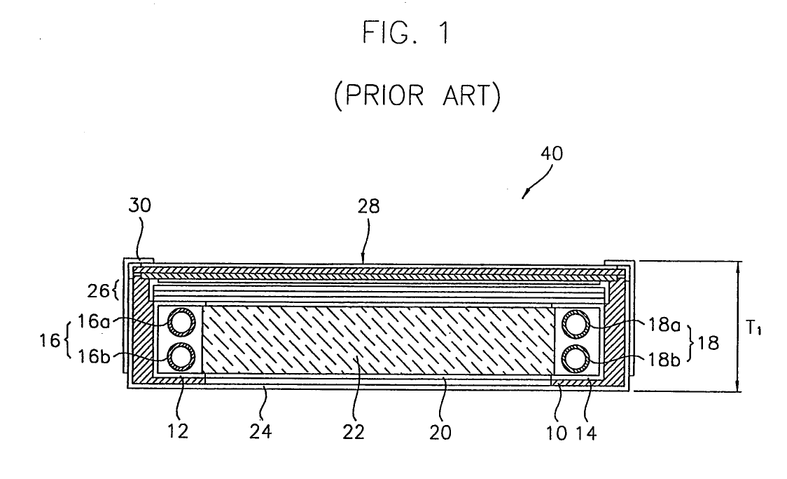

### BEST MODE FOR CARRYING OUT THE INVENTION

Reference will now be made in detail to the preferred embodiments of the present invention, examples of which are illustrated in the accompanying drawings. Hereinafter, preferred embodiments are described with reference to the accompanying drawings.

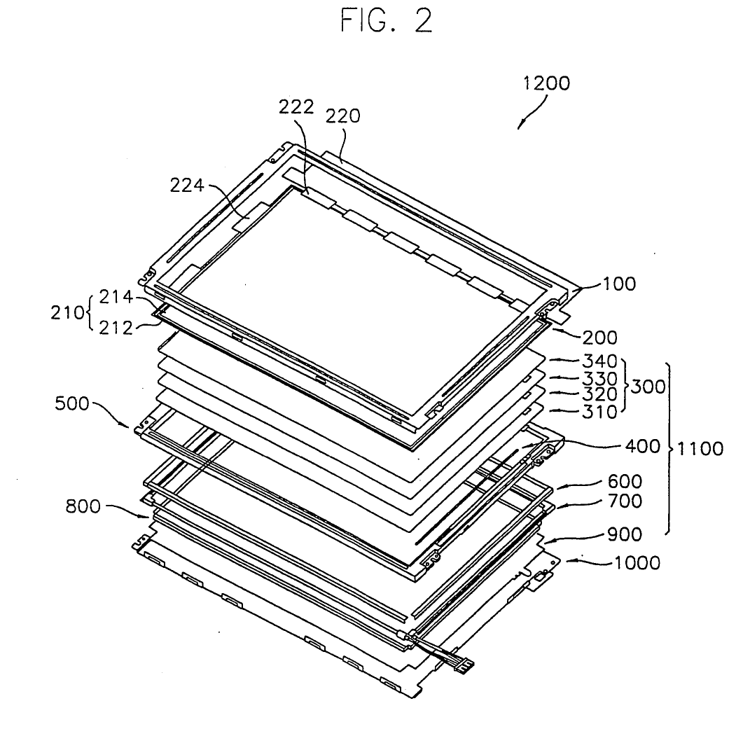

FIG. 2 is a disassembled perspective view of a liquid crystal display apparatus in accordance with a first preferred embodiment of the present invention.

Referring to FIG. 2, a liquid crystal display apparatus 1200 includes a liquid crystal display module for displaying an image in response to an image signal, and a case (not shown) having front and rear cases and for receiving the liquid crystal display module.

The liquid crystal display module includes a display unit 200 having a liquid crystal display panel for displaying the image and a back light assembly 1100 for providing a light to the display unit 200. The display unit 200 is mounted on the back light assembly 1100 and fixed thereto by means of a top chassis 100 combined with the back light assembly 900.

The display unit 200 includes a liquid crystal display panel (hereinafter, referred to as an LCD panel) 210, a panel driving printed circuit board for driving the panel (hereinafter, referred to as an integrated PCB) 220, a data tape carrier package (data TCP) 222 and a gate tape carrier package (gate TCP) 224. A first driving circuit connected to the gate TCP 224 so as to drive a gate line of the liquid crystal display panel 210 and a second driving circuit connected to the data TCP 222 so as to drive a data line of the liquid crystal display panel 210 are mounted on the integrated PCB 220. The integrated PCB is combined with only one side portion of the LCD panel 210 through the data TCP 222.

The LCD panel 210 includes a TFT substrate 212, a color filter substrate 214 and a liquid crystal (not shown) interposed between the TFT substrate 210 and the color filter substrate 214.

The TFT substrate 212 is a transparent glass substrate on which a plurality of thin film transistors (TFTs) is formed in a matrix configuration. Data lines are connected to source terminals of the TFTs and gate lines are connected to gate terminals of the TFTs. Also, drain terminals of the TFT are connected to pixel electrodes made of indium tin oxide (ITO) that is a transparent conductive material.

As electrical signals are applied to the gate lines and data lines, electrical signals are input into the gate terminals and data terminals, respectively. These electrical input signals turn on or turn off the TFTs, so that they are applied to the pixel electrodes through the drain terminals of the TFTs.

A color filter substrate 214 is disposed so as to face the TFT substrate 212. The color filter substrate 214 includes R, G, B color pixels formed thereon by a thin film process, for displaying colors. A transparent common electrode of ITO is also formed on the color filter substrate 214 including the R, G, B color pixels.

As an electric power is applied to the gate terminals and the source terminals of the TFTs formed on the TFT substrate 212, the TFTs are turned on. By turning on the TFT, an electric field is formed between the pixel electrodes of the TFT substrate 212 and the common electrode of the color filter substrate 214. The formed electric field varies a pre-tilt angle of the liquid crystal interposed between the TFT substrate 212 and the color filter substrate 214 and thus the optical transmissivity of the liquid crystal is varied, so that a desired image is obtained.

In order to control an aligned angle of the liquid crystal and an aligned timing of the liquid crystal in the LCD panel 210, a driving signal and timing signal is applied to the gate lines and the data lines.

The data TCP 222 shown in FIG. 2 is one kind of flexible PCB and is coupled to the source side of the LCD panel 210 to decide an applying timing of the data driving signal and the gate TCP 224 is also one kind of flexible PCB and is coupled to the gate side of the LCD panel 210 to decide an applying timing of the gate driving signal.

The integrated PCB 220 is coupled to the data TCP 222 to receive an image signal from an external device and apply driving signals to the data lines and gate lines. The integrated PCB 220 includes a source part for receiving an image signal generated from an external information processing unit such as computers and applying data driving signals to the data lines of the LCD panel 210 and a gate part for applying gate driving signals to the gate lines of the LCD panel 210.

That is, the integrated PCB 220 generates data driving signals, gate driving signals and plural timing signals for applying these data driving signals and gate driving signals at a proper timing. The integrated PCB 220 applies the generated data driving signals to the data lines of the LCD panel 210 through the data TCP 222 and applies the generated gate driving signals to the gate lines of the LCD panel 210 through the gate TCP 224.

On the other hand, the source and gate parts formed in the integrated PCB 220 may be separately formed in respective printed circuit boards. Particularly, the integrated PCB 220 in which the source part is formed therein is connected to the data TCP 222 and the gate part separated from the integrated PCB 220 is formed in another printed circuit board and connected to the gate TCP 224.

The backlight assembly 1100 includes a lamp part 700 for generating the light, a light guiding plate 800 for guiding the light to the display unit 200, a reflecting plate 900 for reflecting the light from the light guiding plate 800, an optical sheet part 300 disposed on the light guiding plate 800, for adjusting the visual angle of the light emitted from the light guiding plate 800, a lamp cover part 600 for protecting the lamp part 700 and reflecting the light emitted from the lamp part 700 to the light guiding plate 800 and mold frame 500 for receiving the reflecting plate 900, the light guiding plate 800, the lamp part 700, the lamp cover part 600 and the optical sheet part 300. Further, the lamp part 700, the light guiding plate 800, the reflecting plate 900 received in the backlight assembly 1100 are fixed to the mold frame 500 by means of a bottom chassis 1000 which receives the mold frame 500 and is combined with a top chassis 100.

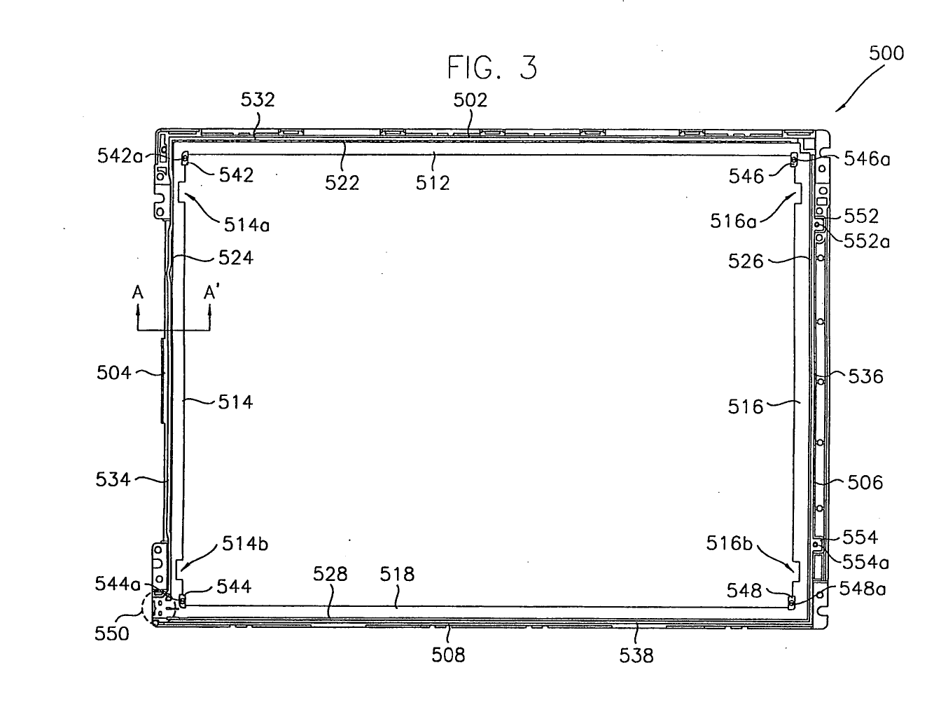

Hereinafter, the constitution of the display unit 200 and the backlight assembly 1100 of the liquid crystal display apparatus will be described with reference to FIGS. 3 to 32.

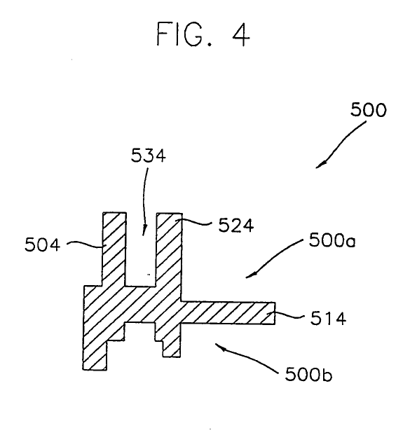

FIG. 3 is a plan view showing the structure of the mold frame shown in FIG. 2 in detail and FIG. 4 is a sectional view showing the structure of the sidewall of the mold frame shown in FIG. 3.

Referring to FIGS. 3 and 4, the mold frame 500 includes first, second, third and fourth sidewalls 502, 504, 506 and 508 integrally connected one after another and first, second, third and fourth bottoms 512, 514, 516, 518 respectively prolonged from the first to the fourth sidewalls 502, 504, 506 and 508. An opening having a predetermined size is formed at a central portion of the mold frame 500 consisting of the first to the fourth bottoms 512, 514, 516 and 518.

First, second, third and fourth stoppers 542, 544, 546 and 548 are respectively formed on corners of the bottom of the mold frame 500. The first to fourth stoppers 542, 544, 546 and 548 are separated from the first to fourth sidewalls 502, 504, 506 and 508, respectively. The first to fourth stoppers 542, 544, 546 and 548 fix the lamp part 700 and the light guiding plate 800 to a position where the lamp part 700 and the light guiding plate 800 are received and prevent the lamp part 700 from being damaged by the movement of the light guiding plate 800. In addition, first, second, third and fourth protuberances 542a, 544a, 546a and 548a are formed on the first to fourth stoppers 542, 544, 546 and 548, respectively. The first to the fourth protuberances 542a, 544a, 546a and 548a guide the bottom chassis 1000 to a combining position thereof. Such functions of the first to the fourth protuberances 542a, 544a, 546a and 548a will be described later.

First and second fixing grooves 514a and 514b are formed at the second bottom 514 by cutting off the second bottom 514 and third and fourth fixing grooves 516a and 516b are formed at the third bottom 516 by cutting off the third bottom 516. The first to fourth fixing grooves 514a, 514b, 516a and 516b receive the ends of the optical sheet part 300 to prevent the optical sheet part 300 from being moved to the lamp part 700.

First, second, third and fourth barrier ribs 522, 524, 526 and 528 are respectively formed on the first to fourth bottom 512, 514, 516 and 518 and the first to fourth barrier ribs 522, 524, 526 and 528 are separated from the first to fourth sidewalls 502, 504, 506 and 508. Accordingly, a first guide groove 532 is formed between the first sidewall 502 and the first barrier rib 522 and a second groove 534 is formed between the second sidewall 504 and the second barrier rib 524. In the same way, a third guide groove 536 is formed between the third sidewall 506 and the third barrier rib 526 and a fourth guide groove 538 is formed between the fourth sidewall 508 and the fourth barrier rib 528. Power supply lines connected to the lamp part 700 are guided by means of the first to fourth guide grooves 532, 534, 536 and 538 and withdrawn to outside through a withdrawing portion 550 formed by partially opening a corner where the second sidewall 504 makes contact with the fourth sidewall 506.

As shown in FIG. 4, the first to fourth guide groove 532, 534, 536 and 538 are formed to have a predetermined depth by means of the first to fourth sidewalls 502, 504, 506 and 508 and the first to fourth barrier ribs 522, 524, 526 and 528. Also, the second bottom 514 is prolonged from a central portion of the second sidewall 504 of the mold frame 500 and the first, third and fourth bottoms 512, 516 and 518 are formed to have the same width with that of the second bottom 514. Accordingly, the receiving space of the mold frame 500 is divided by the first to fourth bottoms 512, 514, 516 and 518 into a first receiving space 500a and a second receiving space 500b. The lamp cover part 600, the lamp part 700, the light guiding plate 800 and the reflecting plate 900 are received in the first receiving space 500a, the display unit 200 is received in the second receiving space 500b and the optical sheet part 300 is received between the light guiding plate 800 and display unit 200.

Further, fifth and sixth protuberances 552a and 554a, which are adjacent to the third guide groove 536, are formed on the third sidewall 506. The fifth protuberance 552a is separated from the sixth protuberance 554a by a predetermined interval. The fifth and sixth protuberances 552a and 554a guide the reflecting plate 900 to a position where the reflecting plate 900 is received by inserting engaging holes of the reflecting plate 900 installed under the light guiding plate 800.

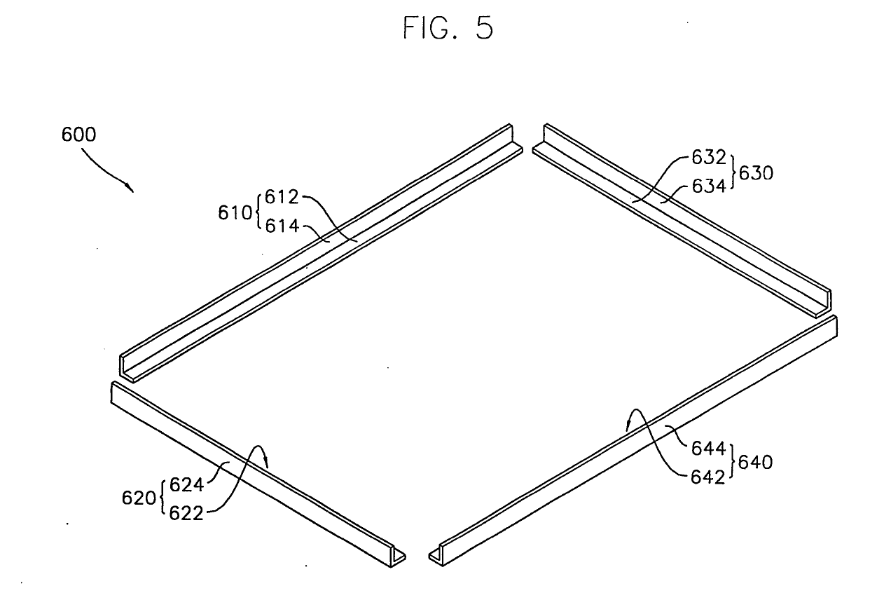

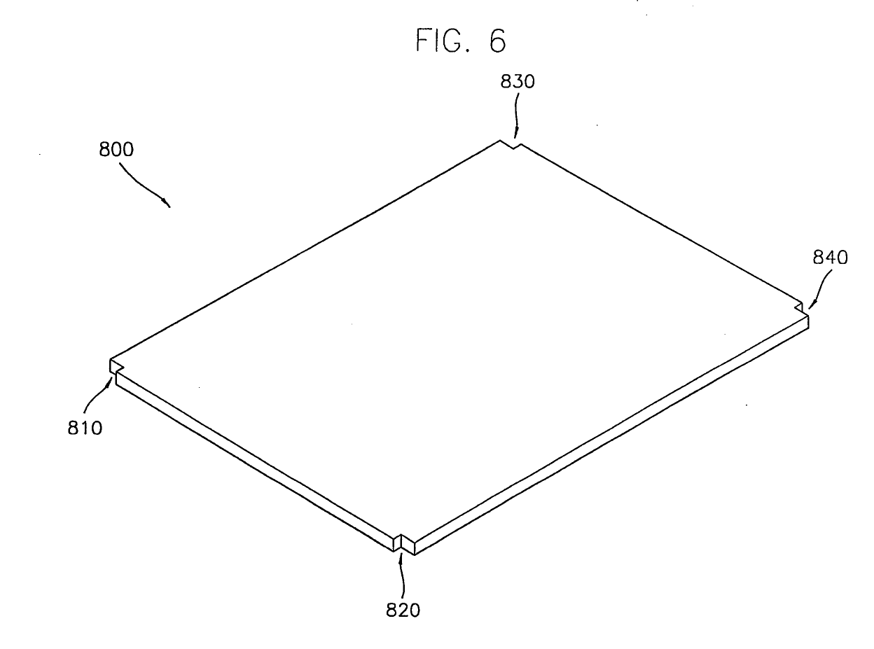

FIG. 5 is a perspective view showing a structure of the lamp cover shown in FIG. 5 and FIG. 6 is a perspective view showing a structure of the light guiding plate shown in FIG. 6.

Referring to FIG. 5, the lamp cover part 600 includes a first lamp cover 610 having first and second reflecting portions 612 and 614, a second lamp cover 620 having third and fourth reflecting portions 622 and 624, a third lamp cover 630 having fifth and sixth reflecting portions 632 and 634 and a fourth lamp cover 640 having seventh and eighth reflecting portions 642 and 644. The first and second reflecting portions 612 and 614 respectively cover the first bottom 512 and the first barrier rib 522, and the third and fourth reflecting portions 622 and 624 respectively cover the second bottom 514 and the second barrier rib 524. Also, the fifth and sixth reflecting portions 632 and 624 respectively cover the third bottom 516 and the third barrier rib 526, and the seventh and eighth reflecting portions 642 and 644 respectively cover the fourth bottom 518 and the fourth barrier rib 528. The first to fourth lamp covers 610, 620, 630 and 640 are disposed on the first to fourth bottoms 512, 514, 516 and 518 of the mold frame 500, respectively and the first to fourth lamp covers 610, 620, 630 and 640 reflect the light from the lamp part 700 toward the light guiding plate 800.

Referring to FIG. 6, the light guiding plate 800 is formed to have a rectangular shape and is of an edge-type having a uniform thickness of both ends thereof. Printed patterns (not shown) are formed on the light guiding plate 800 for increasing the efficiency of the reflection light emitted from the lamp part 700, and the printed patterns become denser according as the printed patterns are spaced more apart from the lamp part 700.

Further, four corners of the light guiding plate 800 are partially cut in order to prevent the light guiding plate 800 from being moved when the light guiding plate 800 is received in the first receiving space 500a, thereby forming first, second, third and fourth clamping jaws 810, 820, 830 and 840. For this purpose, the first to fourth clamping jaws 810, 820, 830 and 840 are respectively combined with the first to fourth stoppers 542, 544, 546 and 548 formed on the first to fourth bottoms 512, 514, 516 and 518.

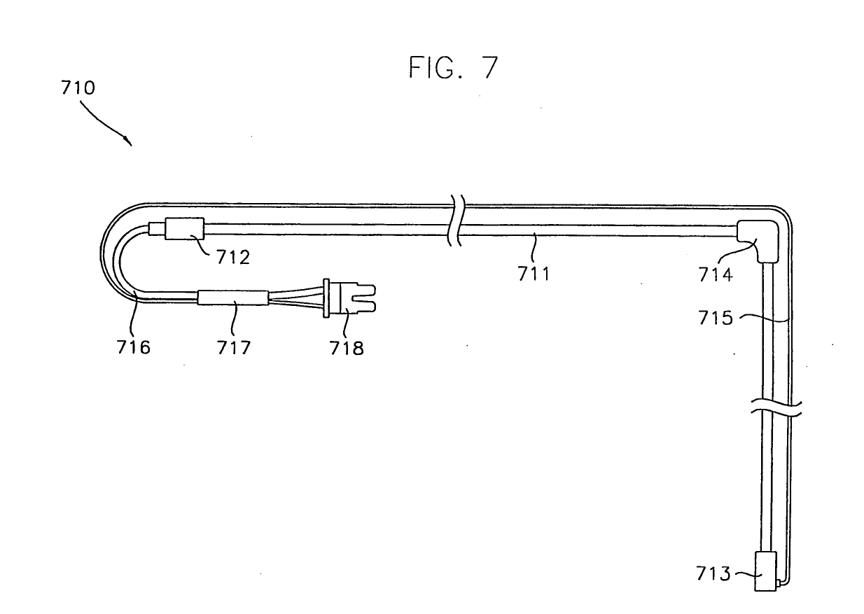

FIGS. 7 to 10 are views showing constitutions of the lamp shown in FIG. 2. In here, two lamps having a L shape are adopted as the lamp part 700. In FIGS. 7 to 10, only one lamp having the L shape (hereinafter, referred to as a first L-shaped lamp) is described and the other lamp having the L shape (hereinafter, referred to as a second L-shaped lamp) will be described later.

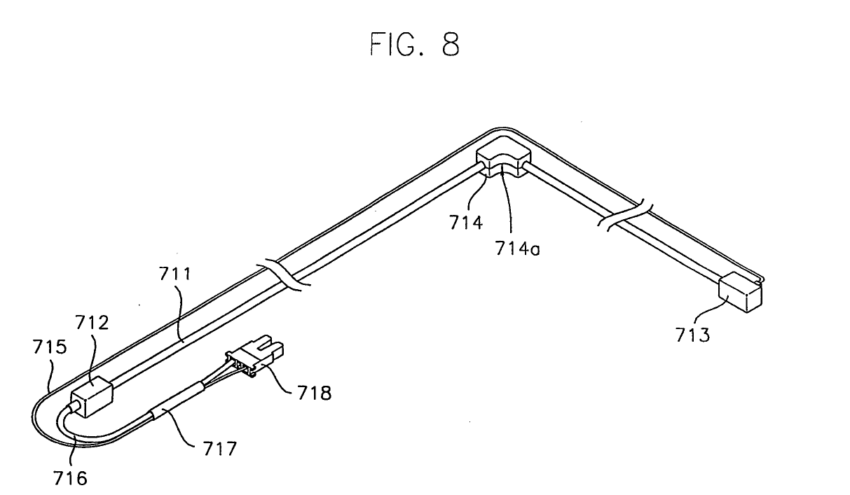

Referring to FIGS. 7 and 8, the first L-shaped lamp 710 has an L shape. The first L-shaped lamp 710 includes a first lamp 711, a first low-voltage power supply line 715 connected to a low-voltage electrode (not shown) so as to maintain a voltage level of the low-voltage electrode within a ground level and a first high-voltage power supply line 716 connected to a high-voltage electrode (not shown) so as to supply high voltage to the first lamp 711. First and second lamp holders 712 and 713 are respectively combined with first and second ends of the first lamp 711 so that the combined force among the first low-voltage power supply line 715, the first high-voltage power supply line 716 and the first lamp 711 is maintained normally.

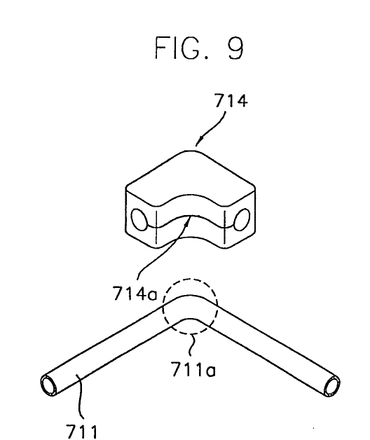

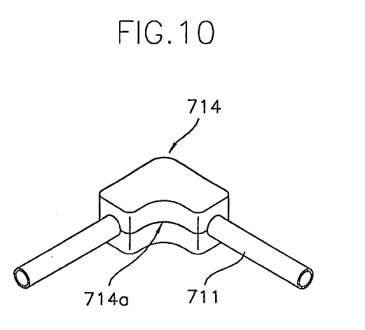

Further, as shown in FIGS. 9 and 10, since the first lamp 711 is formed in the L shape, the first lamp 711 has a bending portion, and a third lamp holder combined with the bending portion to prevent the first lamp 711 from being damaged. At this time, as shown in FIG. 8, one side portion of the third lamp holder 714 is cut by predetermined depth so that the third lamp 711 may be easily combined with the third lamp holder 714 through one side portion.

The first low-voltage power supply line 715 is prolonged to the first lamp holder 712 to which the first high-voltage power supply line 715 is connected. The first low-voltage power supply line 715 and the first high-voltage power supply line 716 are coupled with one another by means of a first shrinkable tube 717. Each of one ends of the first low-voltage power supply line 715 and the first high-voltage power supply line 716 is connected to a connector 718 to which an external power voltage is input. The lamp part 700 further includes the second L-shaped lamp (not shown) formed in a shape identical with that of the first L-shaped lamp 710. The structure for inserting the first and second L-shaped lamp into the first receiving space 500a of the mold frame 500 will be described later.

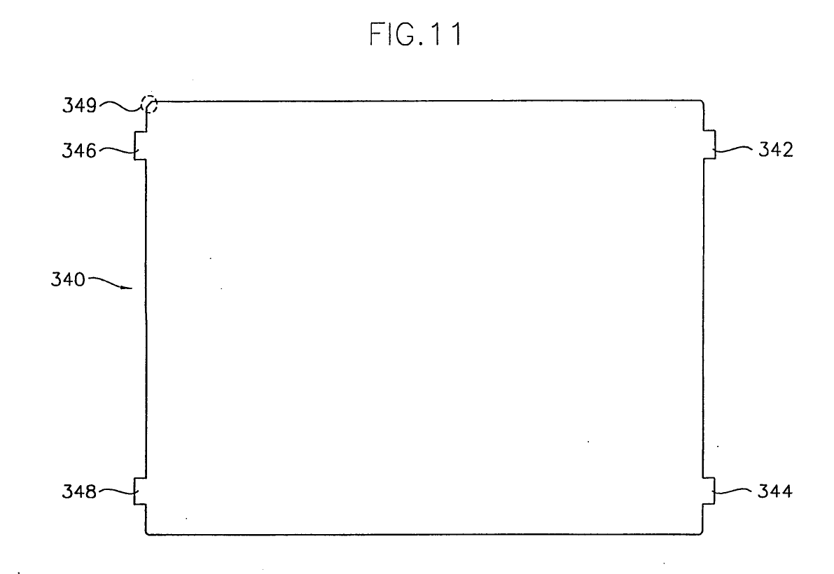

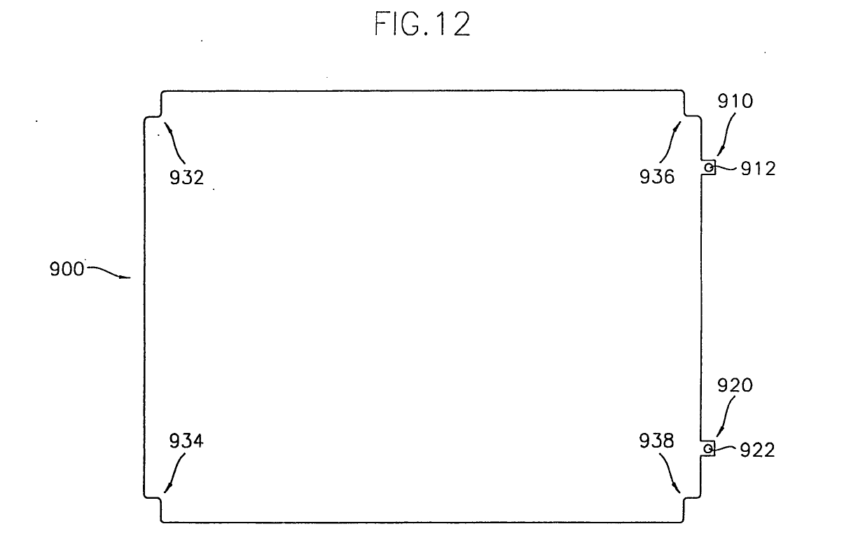

FIG. 11 is a plan view showing the structure of the optical sheet shown in FIG. 2 and FIG. 12 is a plan view showing the structure of the reflecting plate shown in FIG. 2.

As shown in FIG. 2, the optical sheet part 300 is comprised of first to fourth sheets 310, 320, 330 and 340 which diffuse or concentrate the light emitted from the light guiding plate 800. Though the first to fourth sheets 310, 320, 330 and 340 respectively operate differentiated-optical functions in respect to the light emitted from the light guiding plate 800, the outer structures thereof are same with each other. So, the fourth optical sheet 340 is described as an example of the optical sheet part 300.

As shown in FIG. 11, the fourth optical sheet 340 has a size corresponding to that of the light guiding plate 800. The fourth optical sheet 340 is received in the second receiving space 500b of the mold frame 500 and disposed on the light guiding plate 800. At this time, the first, second and third optical sheets 310, 320 and 330 are received between the fourth optical sheet 340 and the light guiding plate 800 in order.

The both ends of the fourth optical sheet 340, that is at the both ends corresponding to the first to fourth fixing grooves 514a, 514b, 516a and 516b formed in the second and third bottoms 514 and 516, first to fourth wing portions 342, 344, 346 and 348 are formed in the fourth optical sheet 340 by partially prolonging the both ends of the fourth optical sheet 340. In the same manner, wing portions such as the first to fourth wing portions 342, 344, 346 and 348 are formed in each of both ends of the first, second and third optical sheets 310, 320 and 330.

Further, a first location guiding portion 349 is formed at a corner among four corners of each of the first to fourth optical sheets 310, 320, 330 and 340 by cutting off the corner by a predetermined size as shown in FIG. 11. The first location guiding portion 349 exactly guides the receiving positions of each of the first to fourth optical sheets 310, 320, 330 and 340 when the first to fourth optical sheets 310, 320, 330 and 340 are received in the second receiving space 500b of the mold frame 500. Accordingly, a second location guiding portion (not shown) is formed at a corner adjacent to the third stopper 546 among four corners of the second receiving space 500b of the mold frame 500 to have a shape matching that of the first location guiding portion 349.

Referring to FIG. 12, the reflecting plate 900 is formed to have a size capable of covering the lamp part 700 and light guiding plate 800 received in the first receiving space 500a. The reflecting plate 900 is disposed under the light guiding plate 800 and reflects the light leaked from the light guiding plate 800 thereto.

First and second prolonged portions 910 and 920 are formed at one end portions of the reflecting plate 900 corresponding to the third sidewall 506 of the mold frame 500 by partially prolonging the one end portion of the reflecting plate 900. Particularly, the first and second prolonged portions 910 and 920 are formed at a position corresponding to the fifth and sixth protuberances 552a and 554a formed on upper surface of the third sidewall 506.

A first clamping hole 912 combined with the fifth protuberance 552a is formed in the first prolonged portion 910 by perforating a predetermined portion thereof and a second clamping hole 922 combined with the sixth protuberance 554a is formed in the second prolonged portion 920 by perforating a predetermined portion thereof. The fifth and sixth protuberances 552a and 554a not only guide the reflecting plate 900 to a position where the reflecting plate 900 is received but also prevent the reflecting plate 900 from being moved by inserting into the first and second clamping holes 912 and 922.

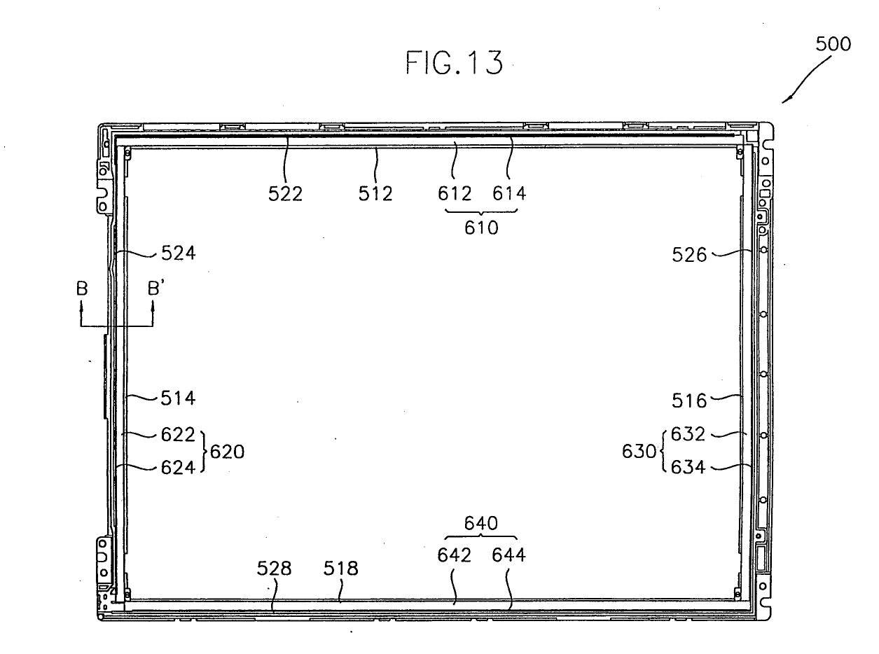

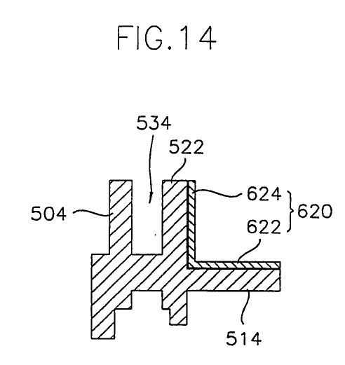

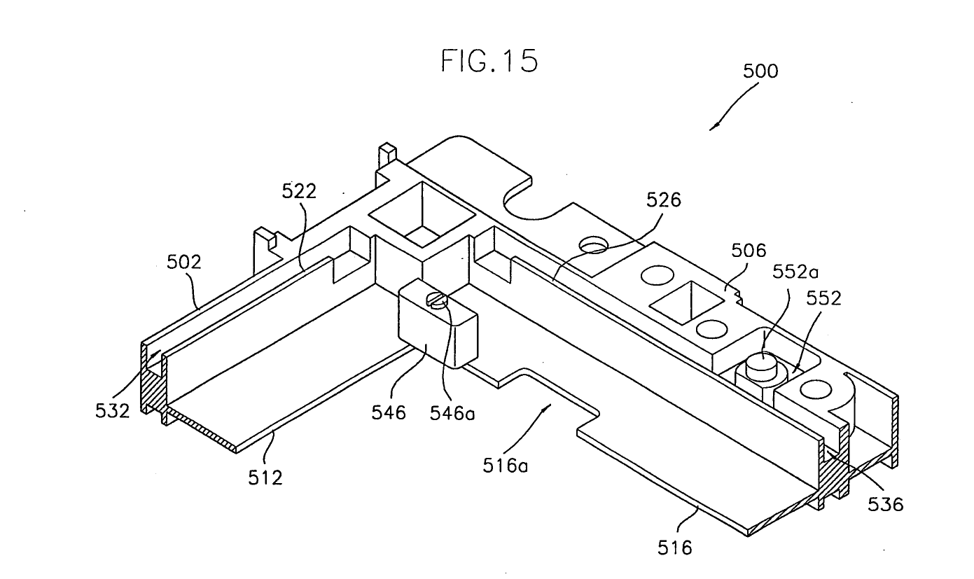

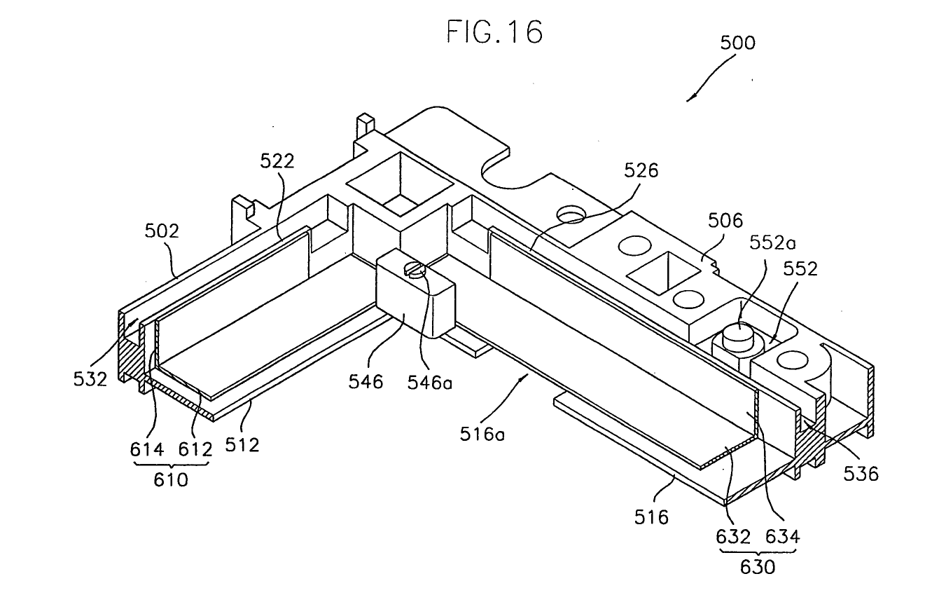

FIG. 13 is a plan view showing a state that the lamp cover is received in the mold frame shown in FIG. 2 and FIG. 14 is a sectional view taken along the line B-B′ in FIG. 13 for showing an assembled structure between the mold frame and the lamp cover. FIGS. 15 and 16 are partially cut perspective views showing the structure of the third stopper shown in FIG. 3.

Referring to FIG. 13, the first lamp cover 610 is received in the first receiving space 500a to cover the first bottom 512 of the mold frame 500 and the first barrier rib 522. At this time, to easily assemble the liquid crystal display apparatus, it is preferable that the first lamp cover 610 is fixed to the first bottom 512 by means of an adhesive tape or the like. In the same manner, the second lamp cover 620 covers the second bottom 514 and the second barrier rib 524, the third lamp cover 630 covers the third bottom 516 and the third barrier rib 526 and the fourth lamp cover 640 covers the fourth bottom 518 and the fourth barrier rib 528.

As shown in FIGS. 14 to 16, the first to fourth lamp covers 610, 620, 630 and 640 are formed to have a size which can sufficiently cover the first to fourth barrier ribs 522, 524, 526 and 528, respectively. If the first to fourth barrier ribs 522, 524, 526 and 528 are not sufficiently covered by means of the first to fourth lamp covers 610, 620, 630 and 640, it is not able to avoid occurrence of the light loss due to decreasing a reflected amount of the light generated from the lamp part 700. Accordingly, it is important to obtain a reflection area of the first to fourth lamp covers 610, 620, 630 and 640 to minimize the loss of the light emitted from the lamp part 700.

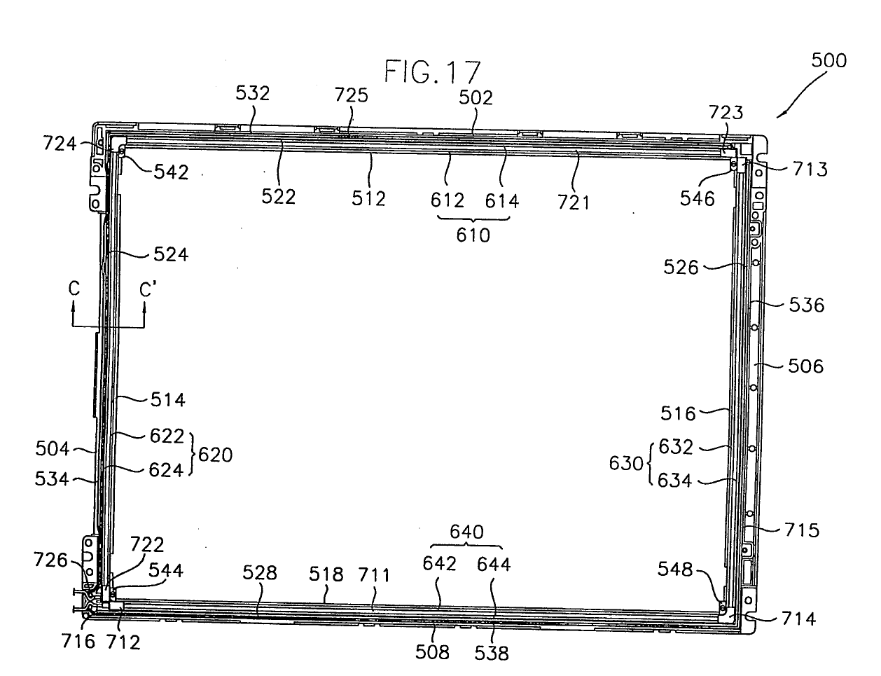

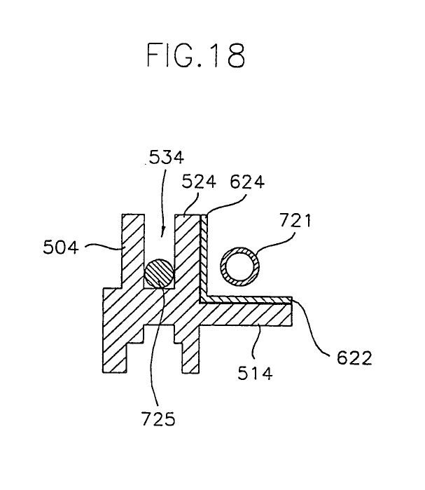

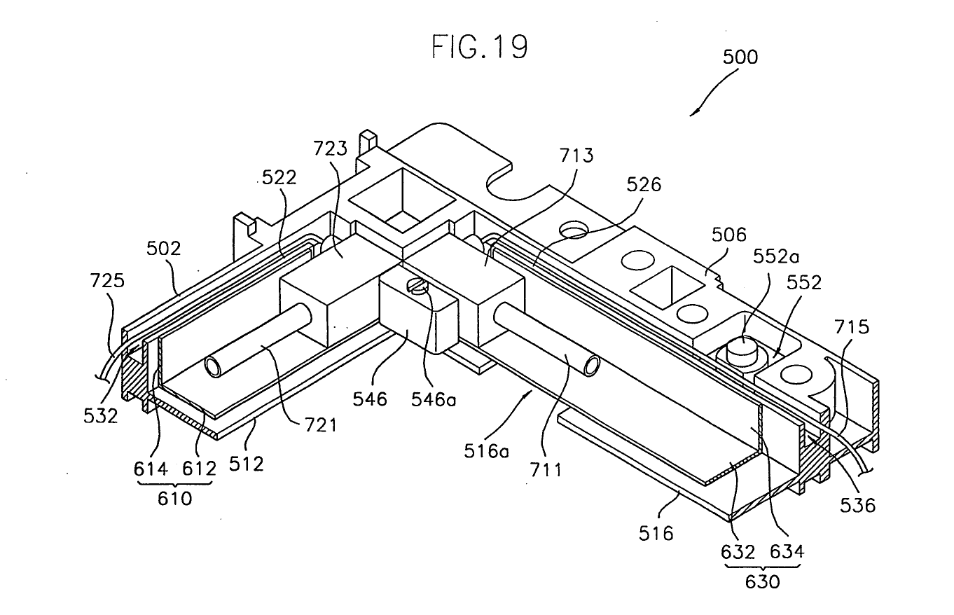

FIG. 17 is a plan view showing a state that the lamp part is received in the mold frame shown in FIG. 13 and FIG. 18 is a sectional view taken along the line C-C′ in FIG. 17 for showing an assembled structure between the mold frame, the lamp cover and the lamp part 700. FIG. 19 is a partially cut perspective view showing an assembled structure between the first and third lamp covers received in the second stopper side and the second and fifth lamp holders in detail.

Referring to FIG. 17, the first L-shaped lamp 710 is received on the upper surfaces of the third and fourth lamp covers 630 and 640 disposed on the third and fourth bottoms 516 and 518. The first lamp holder 712 is inserted between the second stopper 544 and the fourth barrier rib 528 and the second lamp holder 713 is inserted between the third stopper 546 and the third barrier rib 526. The third lamp holder 714 is inserted between the fourth stopper 548 and a corner where the third barrier rib 526 makes contact with the fourth barrier rib 528.

As shown in FIG. 19, since the second lamp holder 713 is tightened by means of the third stopper 546 and the third barrier rib 526, the second lamp holder 713 is formed to have a size that is not disengaged from the mold frame 500. Also, the first lamp holder 712 is tightened by means of the second stopper 544 and the third barrier rib 526 and the third lamp holder 714 is tightened by means of the fourth stopper 548 and the fourth barrier rib 528, thereby receiving the first L-shaped lamp 710 in the mold frame 500.

In the same manner, the second L-shaped lamp 720 is received on the upper surfaces of the first and second lamp covers 610 and 620 respectively combined with the first and second bottoms 512 and 514. The fourth lamp holder 722, which is combined with the second high-voltage power supply line 726 which applies the high voltage to the second L-shaped lamp 720, is inserted between the second stopper 544 and the second sidewall 504. The fifth lamp holder 723, which is combined with the second low-voltage power supply line 725 which applies the low voltage to the second L-shaped lamp 720, is inserted between the third stopper 546 and the first barrier rib 522. The sixth lamp holder 724 combined with a bending portion of the second L-shaped lamp 720 is inserted between the first stopper 542 and the first barrier rib 522.

At that time, as shown in FIG. 19, since the fifth lamp holder 723 is tightened by means of the third stopper 546 and the first barrier rib 522, the fifth lamp holder 723 is formed to have a size that is not disengaged from the mold frame 500. Also, the fourth lamp holder 722 is tightened by means of the first stopper 542 and the first barrier rib 522 and the sixth lamp holder 724 is tightened by means of the second stopper 544 and the second sidewall 504, thereby receiving the second L-shaped lamp 720 in the mold frame 500.

In the mean time, the first low-voltage power supply line 715 which applies the low voltage to the first L-shaped lamp 710 is guided toward the first lamp holder 712 through the third and fourth guide grooves 536 and 538 and withdrawn from the mold frame 500 to an exterior through the withdrawing portion 550.

Further, the second low-voltage power supply line 725 which applies the low voltage to the second L-shaped lamp 720 is guided toward the fourth lamp holder 722 through the first and second guide grooves 532 and 534 and withdrawn from the mold frame 500 to the exterior through the withdrawing portion 550. In addition, the first and the second high-voltage power supply lines 716 and 726 are withdrawn from the mold frame 500 to the exterior through the withdrawing portion 550. The structure of the withdrawing portion 550 will be described with reference to drawings in detail.

As shown in FIG. 18, the second low-voltage power supply line 725 is guided to the exterior after completely inserting into the first and second guide grooves 532 and 534, and the first low-voltage power supply line 715 is guided to the exterior after completely inserting into the third and fourth guide grooves 536 and 538.

As mentioned above, since the first and second low-voltage power supply lines 715 and 725 emit the heat smaller than that emitted from the first and second high-voltage power supply lines 716 and 726, the first and second low-voltage power supply lines 715 and 725 are prolonged toward the first and second high-voltage power supply lines 716 and 726 and withdrawn to the exterior through the withdrawing portion 550. That is, when the first and second high-voltage power supply lines 716 and 726 are prolonged toward the third stopper 546 to withdraw the first and second high-voltage power supply lines 716 and 726 to the exterior, parts of peripheral circuits may be damaged due to the heat emitted from the first and second high-voltage power supply lines 716 and 726. Accordingly, when withdrawing the first and second low-voltage power supply lines 715 and 725, it is able to prevent the parts of the peripheral circuit from being damaged.

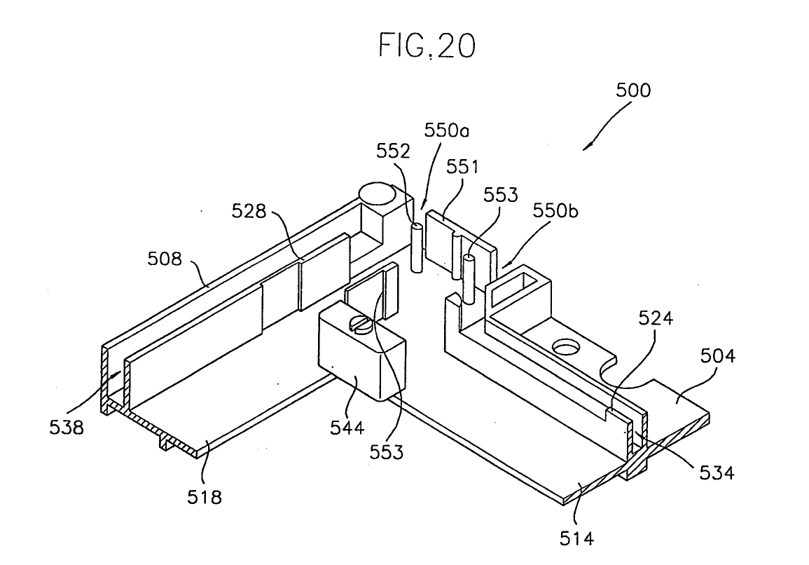

Hereinafter, a structure for withdrawing the first and second low-voltage power supply lines 715 and 725 and the first and second high-voltage power supply lines 716 and 726 to the exterior will be described in detail with reference to FIGS. 20 to 23.

Referring to FIG. 20, first and second withdrawing grooves 550a and 550b are formed on the withdrawing portion 500 formed at a corner adjacent to the second stopper 544 of the mold frame 500 by partially opening the second sidewall 504. The first withdrawing groove 550a is separated from the second withdrawing groove 550b by a predetermined distance. At this time, the predetermined distance between the first withdrawing groove 550a and the second withdrawing groove 550b maintains in a distance that the first and second high-voltage power supply lines 716 and 726 are tightened.

Hereinafter, a portion isolated from the second sidewall 504 by means of the first and second withdrawing grooves 550a and 550b is referred to a first isolation wall 551. First and second guide projections 552 and 553 are formed at the withdrawing portion 500, which are separated from the isolation wall 551 by a predetermined interval. Also, a second isolation wall 553 is formed adjacent to the second stopper 544 and the second isolation wall 553 is formed in an orthogonal direction with respect to the first isolation wall 551.

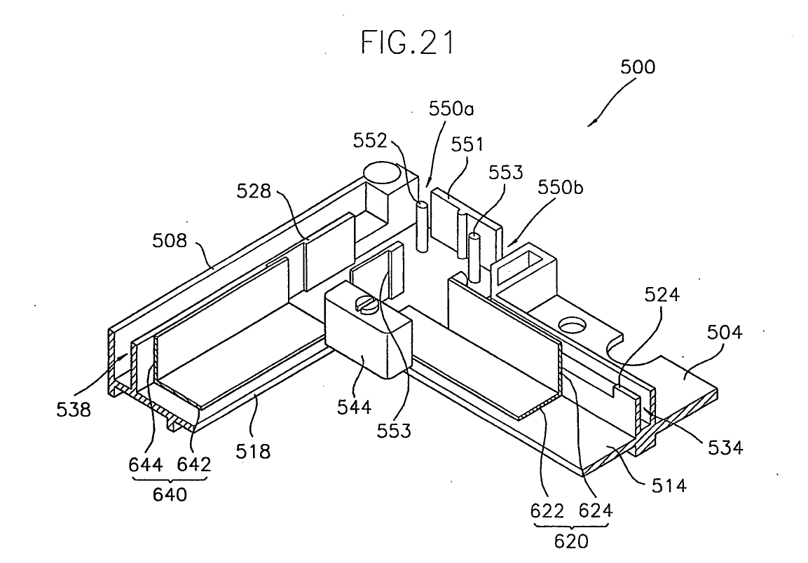

As shown in FIG. 21, the second lamp cover 620 is provided to cover the second bottom 514 and the second barrier rib 524 and the fourth lamp cover 640 is provided to cover the fourth bottom 518 and the fourth barrier rib 528.

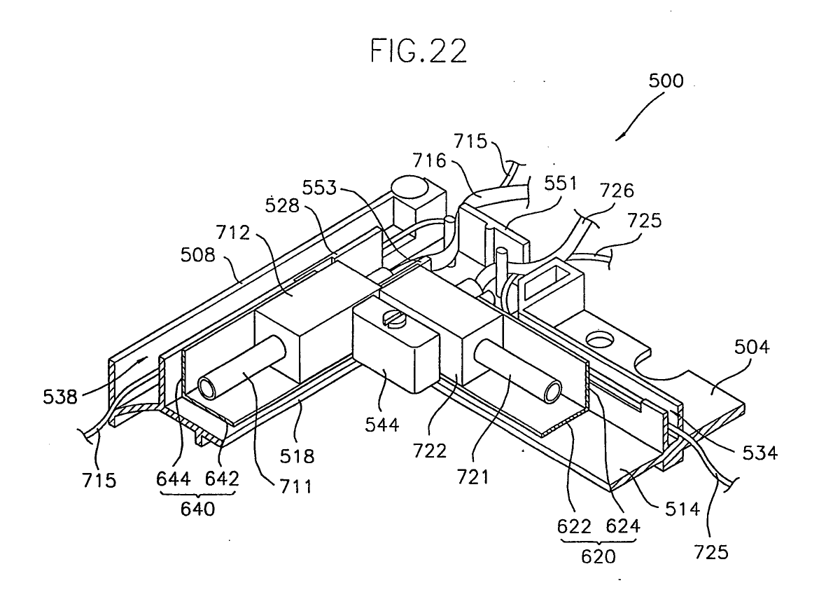

Referring to FIG. 22, the fourth lamp holder 722 capping the end of the second L-shaped lamp 720 is received between the second stopper 544 and the second barrier rib 524. The second L-shaped lamp 720 is electrically connected to the second high-voltage power supply line 726. Also, the first lamp holder 712 capping the end of the first L-shaped lamp 710 is received between the second stopper 544 and the fourth barrier rib 528. The first L-shaped lamp 710 is electrically connected to the first high-voltage power supply line 716.

As shown in FIG. 22, the second low-voltage power supply line 725 electrically connected to the second L-shaped lamp 720 through the fifth lamp holder 723 is guided from the third stopper 546 to the second stopper 544 through the first and second guide grooves 532 and 534. The second low-voltage power supply line 725 is withdrawn to the exterior through the second withdrawing groove 550b after passing the way between the second guide projection 553 and the second sidewall 504. The second high-voltage power supply line 726 connected to the second L-shaped lamp 720 through the fourth lamp holder 722 is guided into the passage between the first guide projection 552 and the second guide projection 553 and withdrawn to the exterior through the second withdrawing groove 550b.

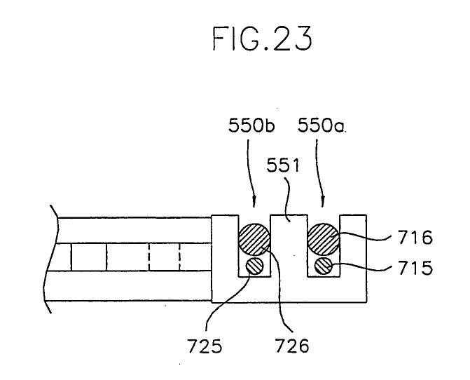

As shown in FIG. 23, the second low-voltage power supply line 725 withdrawn to the exterior through the second withdrawing groove 550b is positioned under the second high-voltage power supply line 726. When the second high-voltage power supply line 726 consisting of electrode wires thicker than that of the second low-voltage power supply line 725 is installed in such a manner that the second high-voltage power supply line 726 is positioned over the second low-voltage power supply line 725, the second high-voltage power supply line 726 is not disengaged from the second withdrawing groove 550b due to the second high-voltage power supply line 726 is tightened by means of the second withdrawing groove 550b. Thus, the second low-voltage power supply line 725 is not disengaged from the second withdrawing groove 550b by means of the second high-voltage power supply line 726.

As shown in FIG. 22, the first low-voltage power supply line 715 electrically connected to the first L-shaped lamp 710 through the second lamp holder 713 is guided from the third stopper 546 to the second stopper 544 through the third and fourth guide grooves 536 and 538. The first low-voltage power supply line 715 is withdrawn to the exterior through the first withdrawing groove 550a after passing the way between the first guide projection 552 and the fourth sidewall 508. The first low-voltage power supply line 716 connected to the first L-shaped lamp 710 through the first lamp holder 712 is guided into the passage between the first guide projection 552 and the second guide projection 553 and withdrawn to the exterior through the first withdrawing groove 550a.

At this time, as shown in FIG. 23, the first low-voltage power supply line 715 withdrawn to the exterior through the first withdrawing groove 550a is positioned under the first high-voltage power supply line 716. When the first high-voltage power supply line 716 consisting of electrode wires thicker than that of the first low-voltage power supply line 715 is installed in such a manner that the first high-voltage power supply line 716 is positioned over the first low-voltage power supply line 715, the first high-voltage power supply line 716 is not deviated from the first withdrawing groove 550a due to the first high-voltage power supply line 716 is tightened by means of the first withdrawing groove 550a. Thus, the first low-voltage power supply line 715 is not disengaged from the first withdrawing groove 550a by means of the first high-voltage power supply line 716.

As shown in FIG. 17, after receiving the lamp part 700 in the first receiving space 500a of the mold frame, the light guiding plate 800 and the reflecting plate 900 are received therein.

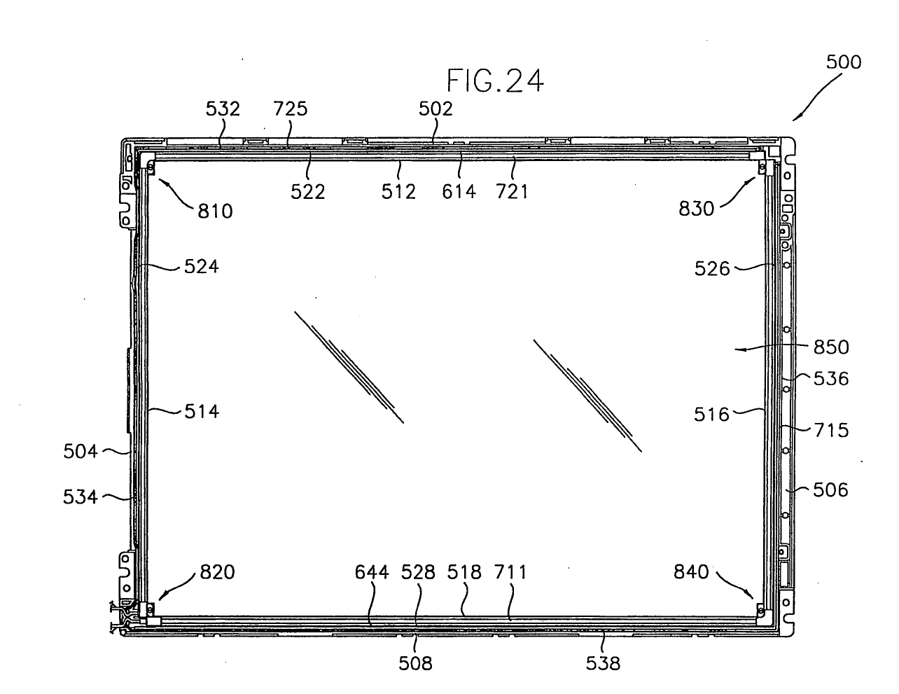

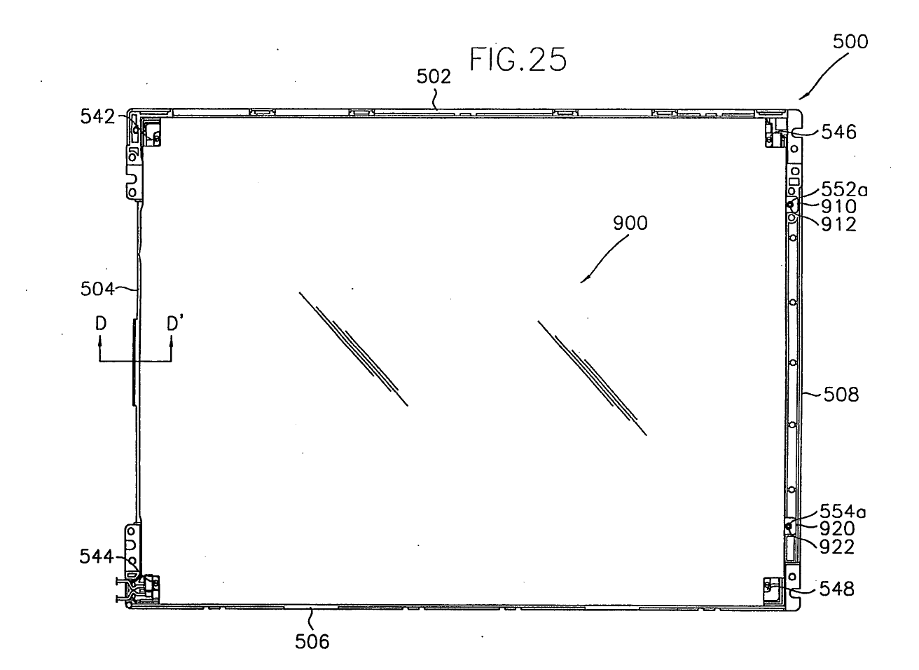

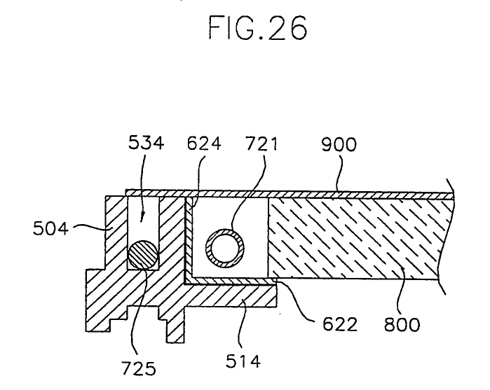

FIG. 24 is a plan view showing a state that the light guiding plate is received in the mold frame shown in FIG. 17. FIG. 25 is a plan view showing an assembled structure between the light guiding plate and the reflecting plate shown in FIG. 24. FIG. 26 is a sectional view taken along the line D-D′ for showing an assembled structure between the light guiding plate and the reflecting plate shown in FIG. 25.

Referring to FIG. 24, the light guiding plate 800 is received on the first to fourth bottoms 512, 514, 516 and 518 of the mold frame 500, thereby combining the first to fourth clamping jaws 810, 820, 830 and 840 of the light guiding plate 800 with the first to fourth stoppers 542, 544, 546 and 548 of the mold frame 500, respectively.

When the light guiding plate 800 is received in the first receiving space 500a of the mold frame 500, the first and second L-shaped lamps 710 and 720 enclose the four side portions of the light guiding plate 800. In other words, the liquid crystal display apparatus has a structure that lamps are respectively installed adjacent to the four side portions of the light guiding plate 800 and the light emitted from the first and second L-shaped lamps 710 and 720 is incident through the four side portions of the light guiding plate 800.

Particularly, as shown in FIG. 26, when viewing the first and second L-shaped lamps 710 and 720 from any position among the first to fourth sidewalls 502, 504, 506 and 508, the liquid crystal display apparatus has a structure that only one lamp is respectively installed at each of the four side portions of the light guiding plate 800. Accordingly, unlike a structure that adopts a plurality of lamps in order to sufficiently obtain an amount of the light in accordance with increase of the size of the light guiding plate 800, it is able to prevent the thickness of the liquid crystal display apparatus from increasing due to adopting the plurality of lamps. Also, since the light is incident into the light guiding plate 800 through the four side portions thereof, the light is uniformly distributed over the whole surface of the light guiding plate 800.

As shown in FIG. 25, the reflecting plate 900 is received in the first receiving space 500a of the mold frame 500 so that the light guiding plate 800 and the first and second L-shaped lamp 710 and 720 are covered by means of the reflecting plate 800. The reflecting plate 900 is guided to the receiving position by means of the fifth and sixth protuberances 552a and 554a formed on the third sidewall of the mold frame 500 and the first and second clamping holes 912 and 922 are respectively formed in the first and second prolonged portions 910 and 920.

Further, since four corner portions 932, 934, 936 and 938 of the reflecting plate 900 are cut away by a predetermined size, the first to fourth protuberances 542a, 544a, 546a and 548a respectively formed on the first to fourth stopper 542, 544, 546 and 548 are exposed to the exterior of the reflecting plate 900.

As described above, after receiving the lamp cover part 600, the lamp part 700, the light guiding plate 800 and the reflecting plate 900 in the first receiving space 500a of the mold frame 500, the mold frame 500 is received in the bottom chassis 1000.

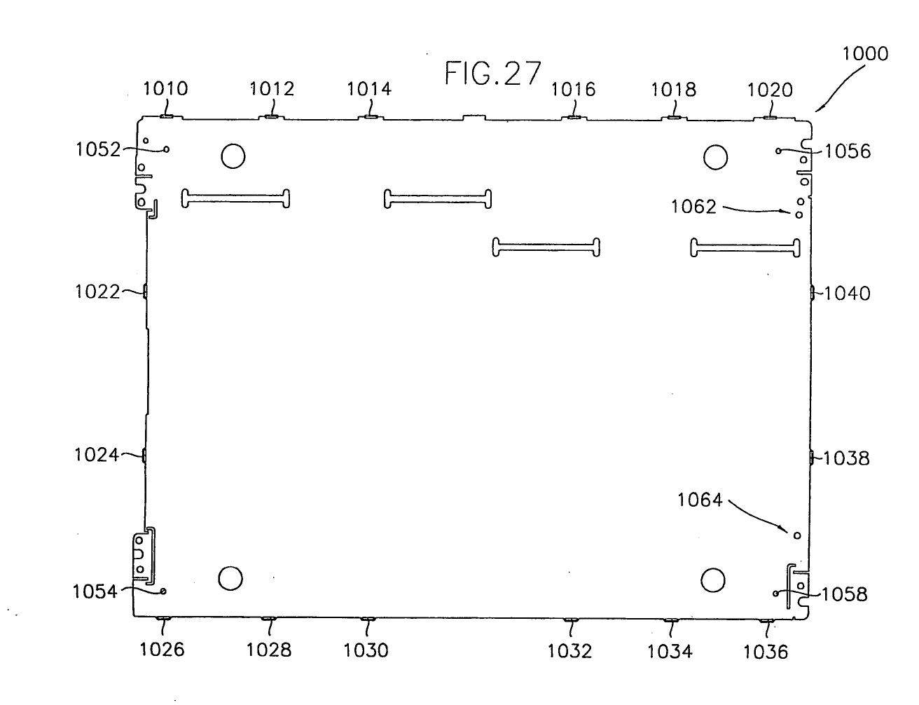

FIG. 27 is a plan view showing a structure of the bottom chassis shown in FIG. 2.

Referring to FIG. 27, the bottom chassis 1000 includes a bottom and a sidewall. First to sixteenth engaging bosses 1010, 1012, 1014, 1016, 1018, 1020, 1022, 1024, 1026, 1028, 1030, 1032, 1034, 1036, 1038 and 1040 are formed at the sidewall of the bottom chassis 1000 so as to combine the bottom chassis 1000 with the top chassis 100. The number of first to sixteenth engaging bosses 1010, 1012, 1014, 1016, 1018, 1020, 1022, 1024, 1026, 1028, 1030, 1032, 1034, 1036, 1038 and 1040 is variable in a range where the combining force between the bottom chassis 1000 and the top chassis 100 is maintained.

First to fourth guide holes 1052, 1054, 1056 and 1058 are formed at the bottom of the bottom chassis 1000 by perforating four corners of the bottom thereof. The first to fourth guide holes 1052, 1054, 1056 and 1058 are formed at positions respectively corresponding to the first to fourth protuberances 542a, 544a, 546a and 548a formed on the first to fourth stopper 542, 544, 546 and 548 of the mold frame 500. When the mold frame 500 is received in the bottom chassis 1000, the first to fourth protuberances 542a, 544a, 546a and 548a are respectively inserted into the first to fourth guide holes 1052, 1054, 1056 and 1058, thereby guiding the mold frame 500 to the receiving position of the bottom chassis 1000.

Further, fifth and sixth guide holes 1062 and 1064 are formed between the third and fourth guide holes 1056 and 1058 formed in the bottom of the bottom chassis 1000. The fifth guide hole 1062 is separated from the sixth guide hole 1064 by a predetermined distance. Also, the fifth and sixth guide holes 1062 and 1064 correspond to the fifth and sixth protuberances 552a and 554a formed on the third sidewall 506 of the mold frame 500, respectively.

In the same manner, when the mold frame 500 is received in the bottom chassis 1000, the fifth and sixth protuberances 552a and 554a are respectively inserted into the fifth and sixth guide holes 1062 and 1064 so as to guide the bottom chassis 1000 to a receiving position thereof. Also, the bottom chassis 1000 receives the fifth and sixth protuberances 552a and 554a through the fifth and sixth guide holes 1062 and 1064, thereby preventing the reflecting plate 900 disposed between the light guiding plate 800 and the bottom chassis 1000 from being disengaged from the light guiding plate 800.

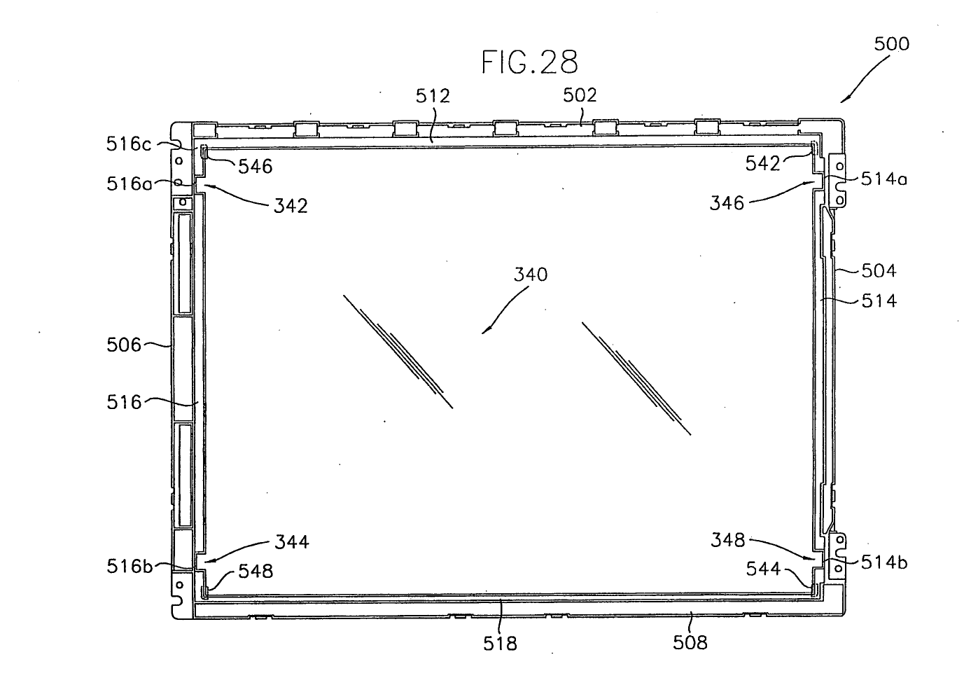

Hereinafter, a structure that the optical sheet and the display unit 200 are received in the second receiving space 500b will be described with reference to FIGS. 28 to 30.

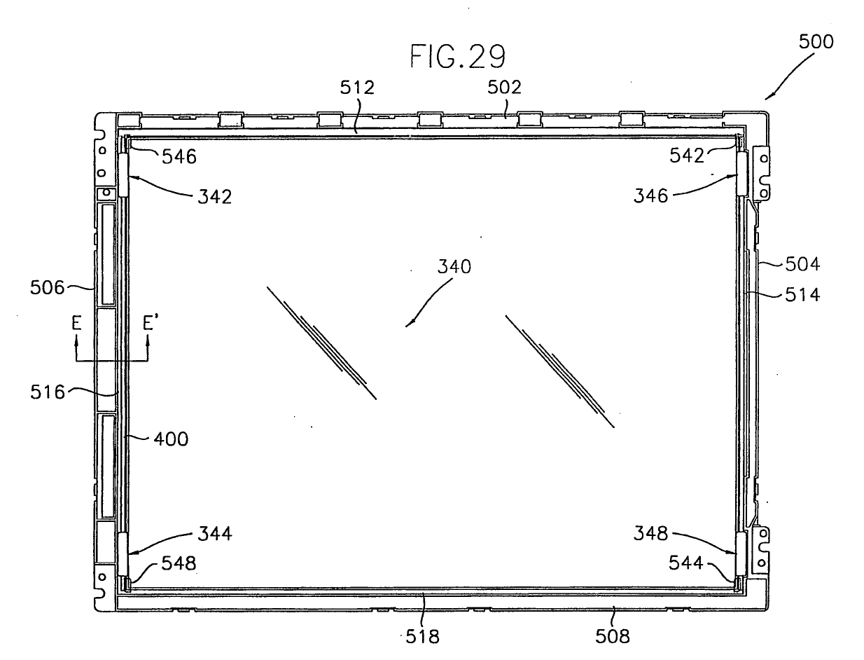

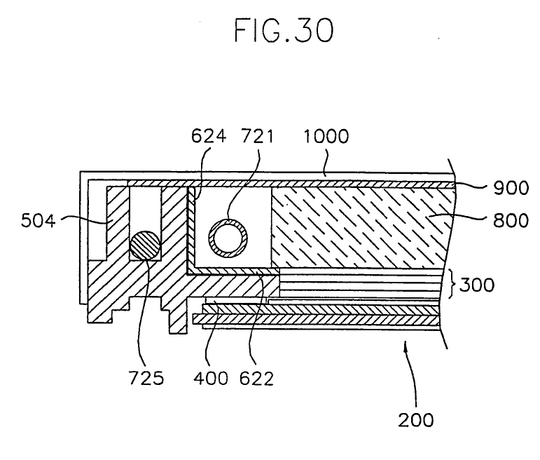

FIG. 28 is a plan view showing the structure that the optical sheet is received in the second receiving space of the mold frame shown in FIG. 25, FIG. 29 is a plan view showing a fixed structure between the mold frame and the optical sheet shown in FIG. 29, and FIG. 30 is a sectional view taken along the line E-E′ for showing the liquid crystal display apparatus shown in FIG. 29.

Referring to FIG. 29, the first to fourth optical sheets 310, 320, 330 and 340 are sequentially received in the second receiving space 500b of the mold frame 500. Each of the wing portions formed in the first to fourth optical sheets 310, 320, 330 and 340 are received in the first to fourth fixing grooves 514a, 514b, 516a and 516b, respectively.

In particular, the fourth optical sheet 340 will be described as an example. The first and second wing portions 342 and 344 of the fourth optical sheet 340 are received in the first and second fixing grooves 514a and 514b formed in the second bottom 514 of the mold frame 500, respectively and the third and fourth wing portions 346 and 348 are received in the third and fourth fixing grooves 516a and 516b formed in the third bottom 516 of the mold frame 500. Accordingly, it is able to prevent the first to fourth optical sheets 310, 320, 330 and 340 from being moved toward the lamp part 700 by combining the first to fourth fixing grooves 514a, 514b, 516a and 516b and the first to fourth wing portions 342, 344, 346 and 348.

At that time, a second location guiding portion 516c, which is corresponding to the first location guiding portions 349 formed at the first to fourth optical sheets 310, 320, 330 and 340, is formed adjacent to the third stopper 546 by cutting away a predetermined portion of the mold frame 500. A receiving direction of the first to fourth optical sheets 310, 320, 330 and 340 is determined by means of the second location guiding portion 516c.

As shown in FIG. 29, an adhesive tape 400 is adhered to the first, the second and the third bottoms 512, 514 and 516 including the first to fourth fixing grooves 514a, 514b, 516a and 516b. The adhesive tape 400 prevents the first to fourth optical sheets 310, 320, 330 and 340 received on the light guiding plate 800 through the second receiving space 500b of the mold frame 500 from being deviated from the light guiding plate 800 toward the display unit 200 received on the fourth optical sheet 340.

Further, as shown in FIG. 30, since the adhesive tape 400 is adhered to upper surfaces of the first, second and third bottoms 512, 514, 516, it is able to prevent the display unit 200 from being damaged due to impact of the display unit 200 against the first to fourth bottoms 512, 514, 516 and 518.

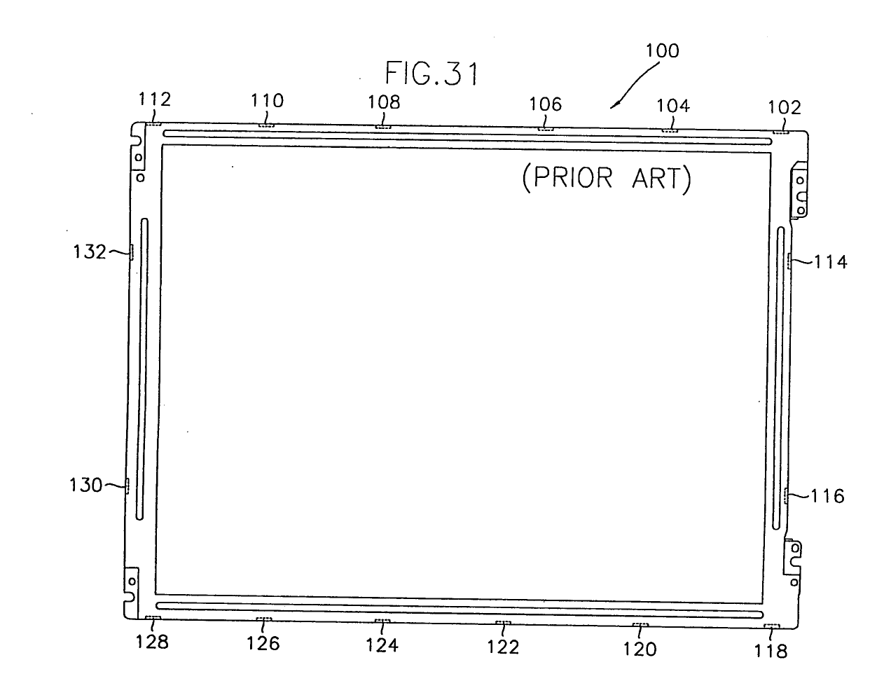

FIG. 31 is a plan view showing a structure of the top chassis shown in FIG. 31.

Referring to FIG. 31, the top chassis 100 includes a bottom which is partially opened to expose an effective display area of the display unit 200 to the exterior and a sidewall corresponding to the first to fourth sidewalls 502, 504, 506 and 508. Also, the top chassis 200 combines with the bottom chassis 200 so as to fix the display unit 200 to the second receiving space 500b of the mold frame 500.

For this purpose, first to sixteenth engaging holes 102, 104, 106, 108, 110, 112, 114, 116, 118, 120, 122, 124, 126, 128, 130 and 132 are formed at the sidewall of the top chassis 100 corresponding to the sidewall of the bottom chassis 1000 by perforating the sidewall of the top chassis 100. The first to sixteenth engaging holes 102, 104, 106, 108, 110, 112, 114, 116, 118, 120, 122, 124, 126, 128, 130 and 132 are respectively engaged with the first to sixteenth engaging bosses 1010, 1012, 1014, 1016, 1018, 1020, 1022, 1024, 1026, 1028, 1030, 1032, 1034, 1036, 1038 and 1040.

As described above, by engaging the first to sixteenth engaging holes 102, 104, 106, 108, 110, 112, 114, 116, 118, 120, 122, 124, 126, 128, 130 and 132 with the first to sixteenth engaging bosses 1010, 1012, 1014, 1016, 1018, 1020, 1022, 1024, 1026, 1028, 1030, 1032, 1034, 1036, 1038 and 1040, it is able to prevent the display unit 200 received in the second receiving space 500b of the mold frame 500 from being moved and deviated. Also, the flexible PCB electrically connected to the display unit 200 is bent by means of the sidewall of the top chassis 100 correspondently combined with the bottom chassis 1000, thereby positioning the flexible PCB at the rear surface of the bottom chassis 1000.

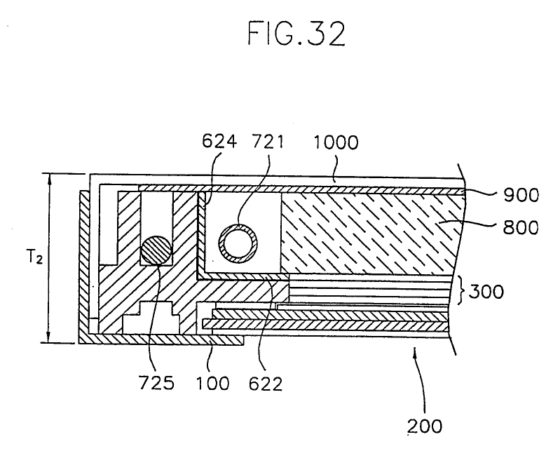

FIG. 32 is a sectional view showing an assembled structure between the bottom chassis that receives the mold frame and the top chassis.

Referring to FIG. 32, the lamp cover part 600, the lamp part 700, the light guiding plate 800 and the reflecting plate 900 are received in the first receiving space 500a of the mold frame 500, the display unit 200 is received in the second receiving space 500b thereof and the optical sheet part 300 is received between the light guiding plate 800 and the display unit 200. At this time, as shown in FIGS. 24 to 32, the first and second L-shaped lamp 710 and 720 are installed to enclose the four side portions of the light guiding plate 800. In other words, the liquid crystal display apparatus has a structure that the lamps are respectively installed adjacent to the four side portions of the light guiding plate 800 and the light emitted from the first and second L-shaped lamps 710 and 720 is incident through the four side portions of the light guiding plate 800.

That is, when viewing the first and second L-shaped lamps 710 and 720 from any position among the first to fourth sidewalls 502, 504, 506 and 508 of the mold frame 500, the liquid crystal display apparatus has a structure that the only one lamp is respectively installed at each of the four side portions of the light guiding plate 800. Accordingly, unlike the structure that adopts a plurality of lamps in order to sufficiently obtain an amount of the light in accordance with increase of the size of the light guiding plate 800, it is able to prevent the thickness T2 of the liquid crystal display apparatus from increasing due to adopting the plurality of lamps. Also, since the light is incident into the light guiding plate 800 through the four side portions thereof, the light is uniformly distributed over the whole surface of the light guiding plate 800. Further, it is able to prevent the part of peripheral circuits from being damaged by means of the heat generated from plurality of lamps due to installation the plurality of lamps at only one side portion of the light guiding plate 800.

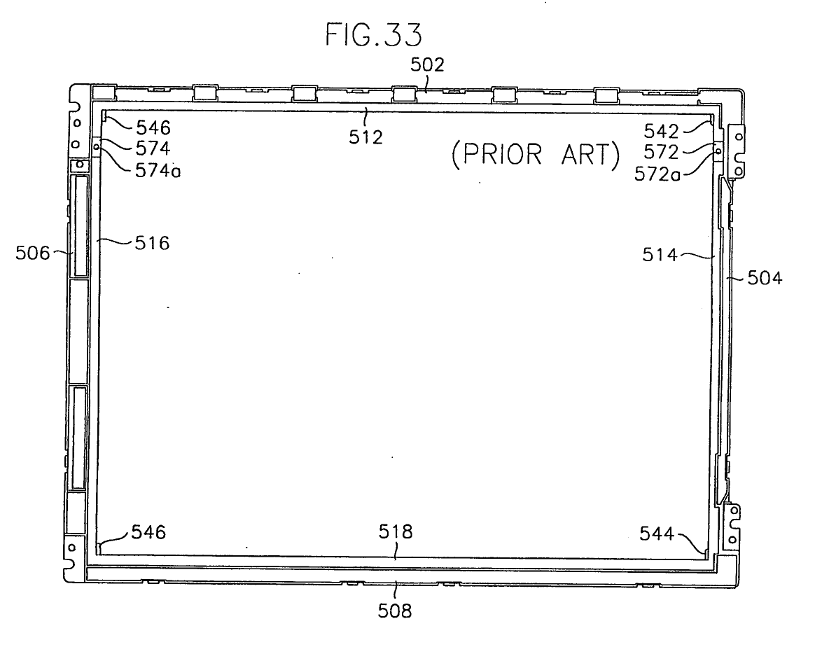

Hereinafter, a second preferred embodiment will be described with reference to FIGS. 33 to 36. In the second embodiment, the like reference numerals are adopted to the elements having the same functions as that of the structure element in the first embodiment.

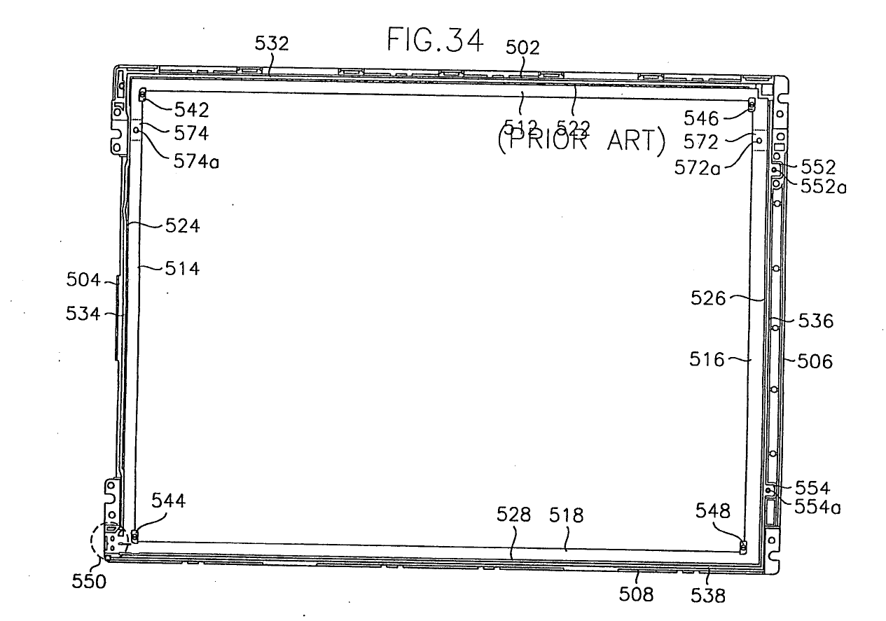

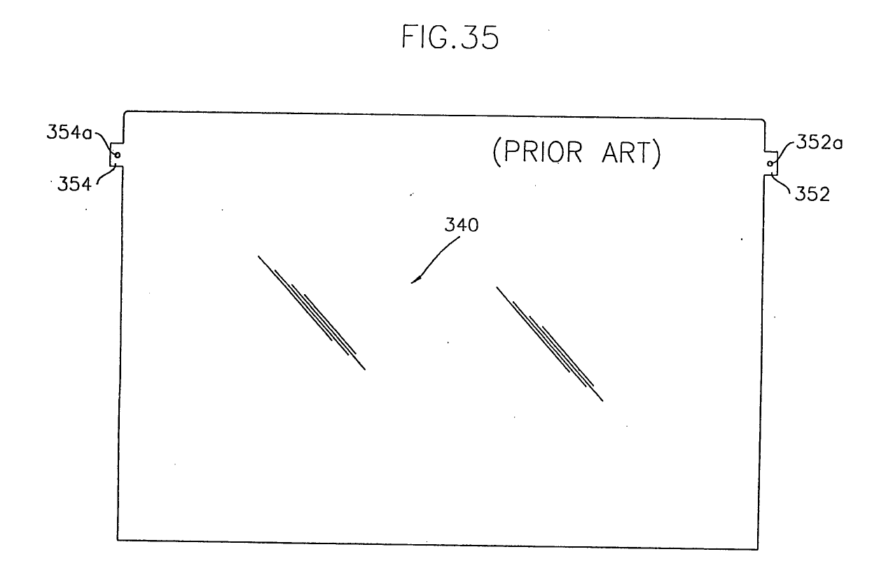

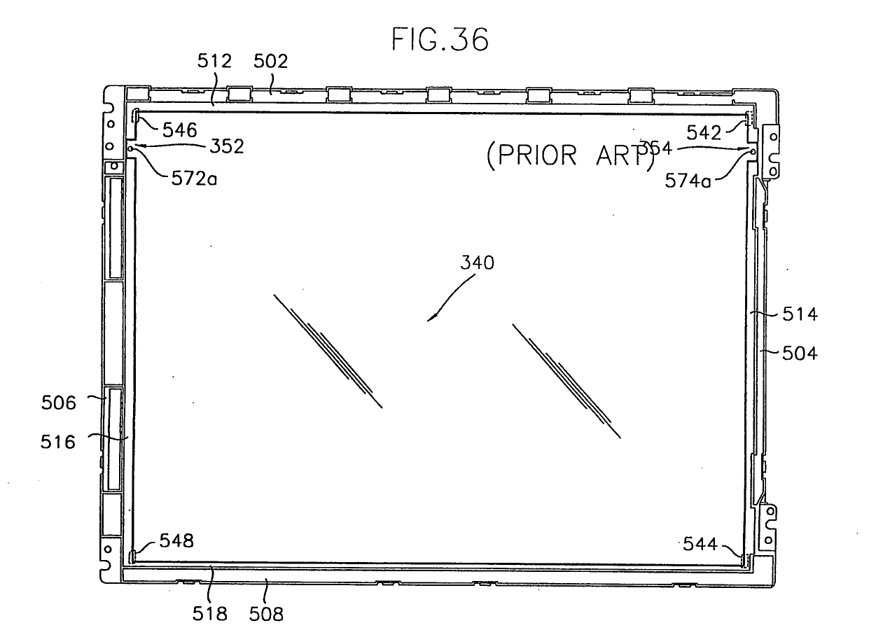

FIG. 33 is a plan view showing a structure of a mold frame according to the second embodiment of the present invention and FIG. 34 is a plan view showing a structure of rear surface of the mold frame shown in FIG. 33. FIG. 35 is a plan view showing a structure of an optical sheet part according to the second embodiment of the present invention and FIG. 36 is a plan view showing an assembled structure between the optical sheet part shown in FIG. 35 and the mold frame shown in FIG. 33.

Referring to FIGS. 33 and 34, a first recess portion 572 and a seventh protuberance 572a is formed on the second bottom 514 instead of the first and second fixing grooves 514a and 514b and a second recess portion 574 and a eight protuberance 574a is formed on the third bottom 516 instead of the third and fourth fixing grooves 516a and 516b.

Particularly, the first recess portion 572 is formed by downwardly recessing the second bottom 514 and the seventh protuberance 572a is formed therein. The second portion 574 is formed by downwardly recessing the third bottom 516 and eight protuberance 574a is formed therein.

As shown in FIG. 35, third and fourth prolonged portions 352 and 354 are formed at both ends of the fourth optical sheet 340 by prolonging the both ends of the fourth optical sheet 340. Further, third and fourth clamping holes 352 and 354 are respectively formed in the third and fourth prolonged portions 352 and 354 by perforating a predetermined portion of the third and fourth prolonged portions 352 and 354. The third and fourth clamping holes 352a and 354a are formed corresponding to the seventh and eighth protuberances 572a and 574a, respectively.

In the first to third optical sheets 310, 320 and 330 among the first to fourth optical sheets 310, 320, 330 and 340, the third and fourth prolonged portions 352 and 354 and the third and fourth clamping holes 352a and 354a are not formed therein because the fourth optical sheet 340 guides the first to third optical sheets 310, 320 and 330 to a receiving position thereof. In other words, when the fourth optical sheet 340 is received on the first to third optical sheets 310, 320 and 330 after the first to third optical sheets 310, 320 and 330 are sequentially received on the light guiding plate 800 through the second receiving space 500b, the fourth optical sheet 340 operates a function that prevents the first to third optical sheets 310, 320, 330 and 340 from being disengaged from the receiving position.

In the same manner, prolonged portions and clamping holes such as the third and fourth prolonged portions 352 and 354 and the third and fourth clamping holes 352a and 354a shown in FIG. 35 may be formed in the first to third optical sheets 310, 320 and 330. In this case, the first to fourth optical sheets 310, 320, 330 and 340 is guided by combining the clamping holes respectively formed therein with the seventh and eighth protuberances 572a and 574a.

On the other hand, the liquid crystal display apparatus adopts the two L-shaped lamps as the lamp part 700. However, according to a liquid crystal display apparatus in accordance with a third embodiment of the present invention, the lamp part 700 may be adopted a lamp having a square shape.

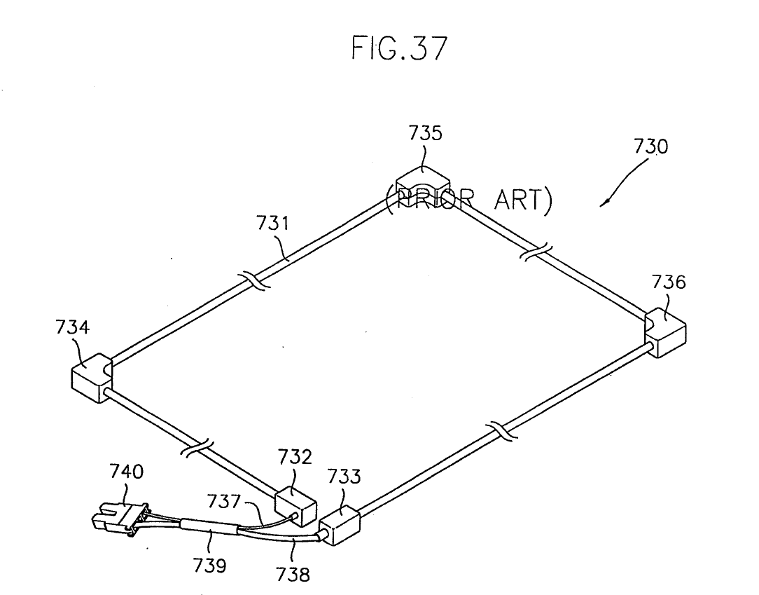

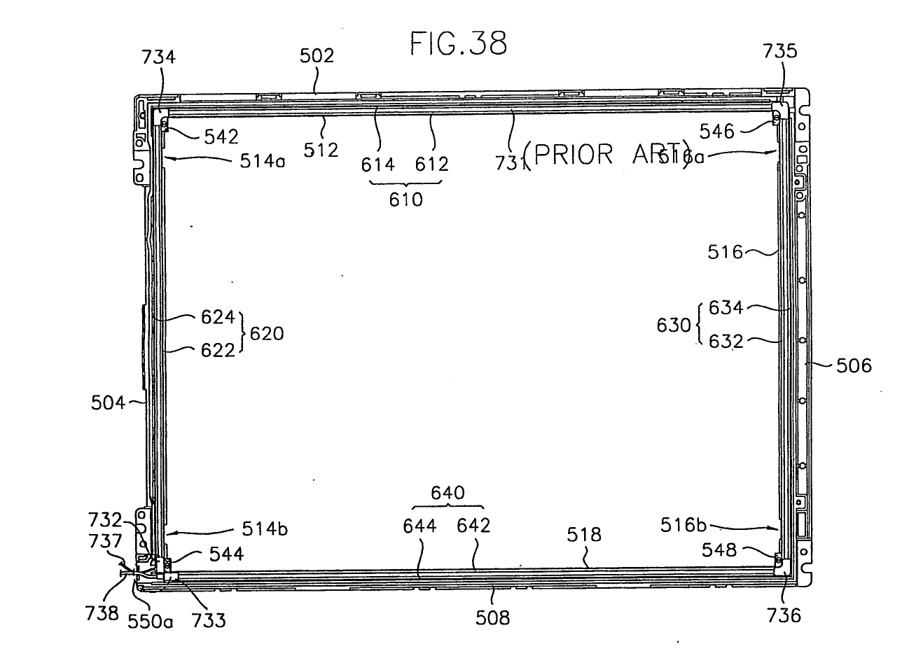

FIG. 37 is a perspective view showing a structure of a lamp according to the third embodiment of the present invention. FIG. 38 is a plan view showing an assembled structure between the mold frame according to the third embodiment of the present invention and the lamp shown in FIG. 37.

Referring to FIG. 37, a third lamp 730 includes the square-shaped lamp 731 formed by partially bending only one lamp. A first end of the square-shaped lamp 731 is capped by means of a seventh lamp holder 732 and second end thereof is capped by means of a eighth lamp holder 733. Further, the square-shaped lamp 731 has three bending portions and the three bending portions are capped by means of ninth, tenth and eleventh lamp holders 734, 735 and 736, respectively, thereby preventing the three bending portions from being damaged. The ninth to eleventh lamp holders 734, 735 and 736 are formed to have a shape identical with that of the third lamp holder 714 capping the bending portion of the first L-shaped lamp 710.

A third low-voltage power supply line 737 is electrically connected to a low-voltage electrode (not shown) installed at the first end of the square-shaped lamp 731 through the seventh lamp holder 732 capping the first end of the square-shaped lamp 731. Also, a third high-voltage power supply line 738 is electrically connected to a high-voltage electrode (not shown) installed at the second end of the square-shaped lamp 731 through the eighth lamp holder 733 capping the second end of the square-shaped lamp 731. The third low-voltage power supply line 737 and the third high-voltage power supply line 738 are coupled with one another by means of a second shrinkable tube 739 and connected to a third connector 740 which receives the external power voltage.

As shown in FIG. 38, the mold frame 500 includes the first to fourth sidewalls 502, 504, 506 and 508 integrally connected one after another and the first to fourth bottoms 512, 514, 516 and 518 are respectively prolonged from the first to fourth sidewalls 502, 504, 506 and 508. The first and second fixing grooves 514a and 514b are formed at the second bottom 514 and the third and fourth fixing grooves 516a and 516b are formed at the third bottom 516. Also, the first to fourth stoppers 542, 544, 546 and 548 are respectively formed on corners of the first to fourth bottoms of the mold frame 500.

The first lamp cover 610 is provided in such a manner that the first lamp cover 610 directly makes contact with the first bottom 512 and the first sidewall 502, and the second lamp cover 620 is provided in such a manner that the second lamp cover 620 directly makes contact with the second bottom 514 and the second sidewall 504. Further, the third lamp cover 630 is provided in such a manner that the third lamp cover 630 directly makes contact with the third bottom 516 and the third sidewall 506, and the fourth lamp cover 640 is provided in such a manner that the fourth lamp cover 640 directly makes contact with the fourth bottom 518 and the fourth sidewall 508.

On the other hand, a withdrawing portion 560 is formed by partially opening a corner portion of the sidewall 504 adjacent to the second stopper 544 so as to withdraw the third low-voltage and third high-voltage power supply lines 737 and 738 to the outside through the withdrawing portion 560.

As shown in figures, the first to fourth lamp covers 610, 620, 630 and 640 directly make contact with the first to fourth sidewalls 502, 504, 506 and 508, respectively. Further, the first to fourth guide grooves 532, 534, 536 and 538 as shown in FIG. 3 are not formed between the square-shaped lamp 731 and the first to fourth sidewalls 502, 504, 506 and 508.

Even if the first to fourth guide grooves 532, 534, 536 and 538 are not formed, since the square-shaped lamp 731 is formed by partially bending the only one lamp, the third low-voltage power supply line 737 and the third high-voltage power supply line 738 are easily withdrawn to the outside through the withdrawing portion 560.

In other words, since the square-shaped lamp 731 is formed by partially bending the only one lamp, the third low-voltage power supply line 737 and the third high-voltage power supply line 738 are positioned in a same corner among the corner portions of the mold frame 500.

Accordingly, the third low-voltage power supply line 737 is not prolonged toward the third high-voltage power supply line 738 and therefore, the first to fourth guide grooves 532, 534, 536 and 538 as shown in FIGS. 3 and 4 for guiding the third low-voltage power supply line 737 are not formed.

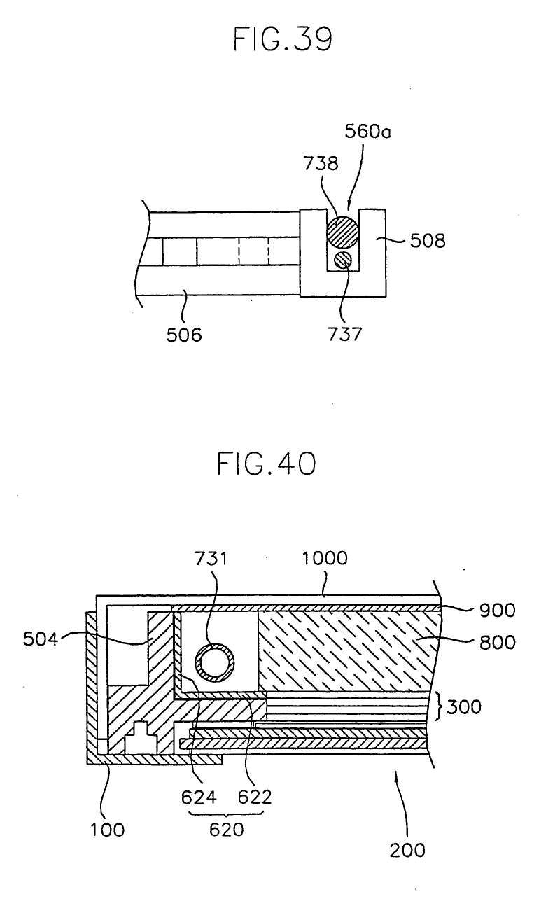

As described above, the third low-voltage power supply line 737 and the third high-voltage power supply line 738 positioned adjacent to the second stopper 544 are withdrawn to the outside through the withdrawing portion 560. Therefore, though the only one withdrawing groove as a third withdrawing groove 560a is formed, it is enough to withdraw the third low-voltage power supply line 737 and the third high-voltage power supply line 738 to the outside as shown in FIG. 39.

FIG. 40 is a sectional view showing an assembled structure of the liquid crystal display apparatus according to the third embodiment of the present invention.

Referring to FIG. 40, the square-shaped lamp 731 is disposed between the side portions of the light guiding plate 800 and the first to fourth sidewalls 502, 504, 506 and 508 of the mold frame 500, and the second lamp cover 620 is received to directly make contact with the second sidewall 504. That is, when viewing the square-shaped lamp 731 at any position among the first to fourth sidewalls 502, 504, 506 and 508, the liquid crystal display apparatus has a structure that only one lamp is respectively installed at each of the four side portions of the light guiding plate 800. Further, guide grooves for withdrawing the third low-voltage power supply line 737 to the outside which grounds one end of the square-shaped lamp 731 are not formed in the mold frame 500. Hence, the thickness and the width of the liquid crystal display apparatus decrease.

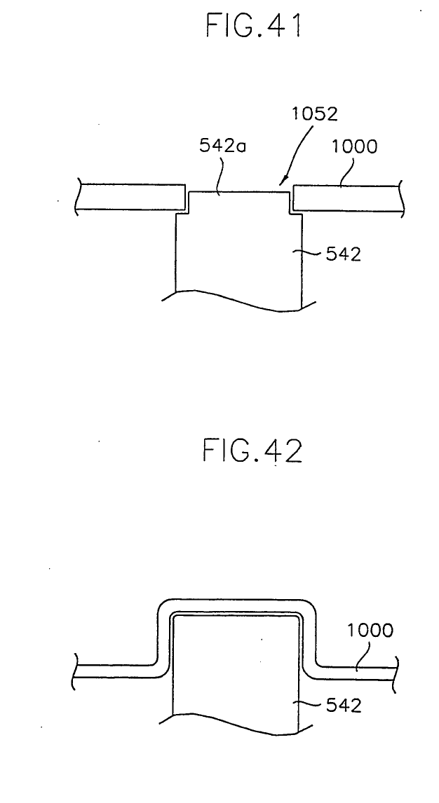

FIGS. 41 and 42 are sectional views showing structures of the first to sixth guide holes shown in FIG. 27.

FIG. 41 is a view for showing a structure that the first to fourth protuberances 542a, 544a, 546a and 548a respectively formed on the first to the fourth stoppers 542, 544, 546 and 548 of the mold frame 500 are exposed to the outside.

On the contrary, as shown in FIG. 42, the first to fourth guide holes 1052, 1054, 1056 and 1058 of the bottom chassis 1000 respectively combined with the first to fourth protuberances 542a, 544a, 546a and 548a may be formed in a seal-shaped so that the first to fourth protuberances 542a, 544a, 546a and 548a are not exposed to the outside.

In the same manner, the fifth and sixth guide holes 1062 and 1064 respectively combined with the fifth and sixth protuberances 552a and 554a formed on the third sidewall 506 of the mold frame 500 may be formed in the seal-shaped.

As shown in FIG. 42, if the first to sixth guide holes 1052, 1054, 1056, 1058, 1062 and 1064 are formed in the seal-shaped, it is able to effectively prevent impurities from being flowed into the inside of the bottom chassis 1000 through the first to sixth guide holes 1052, 1054, 1056, 1058, 1062 and 1064.

According to the above-mentioned liquid crystal display apparatus of the present invention, the lamp for generating the light is comprised of two L-shaped lamps or one square-shaped lamp. The lamp is received between the light guiding plate and the sidewalls of the mold frame so that the four side portions of the light guiding plate is surrounded by means of the lamp. In other words, the liquid crystal display apparatus has a structure that the lamp is respectively installed adjacent to the four side portions of the light guiding plate and the light emitted from the lamp is incident through the four side portions of the light guiding plate. That is, when viewing the lamp having the two L-shaped lamps or the one square-shaped lamp at any position among the sidewalls of the mold frame, the liquid crystal display apparatus has a structure that only one lamp is respectively installed at each of the four side portions of the light guiding plate.

Accordingly, it is able to obtain the amount of the light enough to display the image and prevent the thickness of the liquid crystal display apparatus from increasing.

Further, since the light emitted from the lamp having the two L-shaped lamps or the one square-shaped lamp is incident into the light guiding plate through the four side portions thereof, the light is uniformly distributed over the whole surface of the light guiding plate.

Moreover, since the heat caused by use a plurality of lamps can be easily discharged to the exterior, it is able to prevent the parts of the circuits of the display unit adjacent to the plurality of lamps from being damaged.

This invention has been described above with reference to the aforementioned embodiments. It is evident, however, that many alternative modifications and variations will be apparent to those having skills in the art in light of the foregoing description. Accordingly, the present invention embraces all such alternative modifications and variations as fall within the spirit and scope of the appended claims.

1. A backlight assembly comprising:
a lamp unit for generating a light;
a light guiding unit having a projecting portion for projecting the light, a reflecting portion for reflecting the light to the projecting portion and a side portion which connects the projecting portion with the reflecting portion and receives the light, for guiding the light; and
a receiving unit having a sidewall and a bottom prolonged from the sidewall, for receiving the lamp unit and the light guiding unit,
wherein the lamp unit is disposed between the side portion of the light guiding unit and the sidewall of the receiving unit so as to surround the side portion of the light guiding unit.

2. The backlight assembly of claim 1, wherein an opening is formed at a central portion of the bottom of the receiving unit by a predetermined size.

3. The backlight assembly of claim 2, wherein the receiving unit further comprises protruding portions respectively formed at corners of the bottom of the receiving unit so as to prevent the lamp unit from being deviated from the receiving unit, the protruding portions being separated from the sidewall of the receiving unit by a predetermined interval.

4. The backlight assembly of claim 3, wherein the light guiding unit further comprises clamping portions formed in the light guiding unit by cutting off the light guiding unit, each of the clamping portions being corresponded to the protruding portions.

5. The backlight assembly of claim 4, wherein the protruding portions are combined with the clamping portions to prevent the light guiding unit from being moved toward the lamp unit.

6. The backlight assembly of claim 3, further comprising:
a reflecting unit installed at a lower portion of the light guiding unit and having at least one first guide hole formed in one end thereof, for reflecting the light leaked from the light guiding unit;
a bottom chassis having at least one second guide hole, for preventing the lamp unit, the light guiding unit and the reflecting unit from being deviated from the receiving unit by combining with the receiving unit; and
an optical sheet installed at an upper portion of the light guiding unit, for adjusting brightness of the light emitted from the light guiding unit.

7. The backlight assembly of claim 6, wherein the receiving unit further comprises at least one first guide boss formed on the sidewall thereof and combined with the first guide hole to guide the reflecting unit to a position where the reflecting unit is installed.

8. The backlight assembly of claim 6, wherein the receiving unit further comprises at least one second guide boss respectively formed on upper surfaces of the protruding portions and combined with the second guide hole formed in the bottom chassis to guide the bottom chassis to a location where the bottom chassis is combined with the receiving unit.

9. The backlight assembly of claim 6, wherein at least one third guide hole is formed in a first end and a second end opposite to the first end of the optical sheet, respectively.

10. The backlight assembly of claim 9, wherein the receiving unit further comprises at least one third guide boss formed on the bottom thereof and combined with the third guide hole to prevent the optical sheet from being moved.

11. The backlight assembly of claim 6, wherein the optical sheet further comprises wing portions respectively prolonged from the first and second ends of the optical sheet.

12. The backlight assembly of claim 11, wherein fixing grooves are formed in the receiving unit by cutting off the bottom of the receiving unit so that the fixing grooves receive the wing portions of the optical sheet to prevent the optical sheet from being moved.

13. The backlight assembly of claim 2, further comprising a reflecting plate installed on the bottom of the receiving unit and an outer of the lamp unit, for reflecting the light from the lamp unit to the light guiding unit.

14. A backlight assembly comprising:
a lamp unit for generating a light;
a light guiding unit having a projecting portion for projecting the light, a reflecting portion for reflecting the light to the projecting portion and a side portion which connects the projecting portion with the reflecting portion and receives the light, for guiding the light; and
a receiving unit having a sidewall and a bottom prolonged from the sidewall, for receiving the lamp unit and the light guiding unit,
wherein the lamp unit is disposed between the side portion of the light guiding unit and the sidewall of the receiving unit and includes a first light generating portion which covers a first side portion of the light guiding unit, a second light generating portion which covers a second side portion adjacent to the first portion, a third light generating portion which covers a third side portion facing to the first side portion and a fourth light generating portion which covers a fourth side portion facing to the second side portion and adjacent to the third side portion.

15. The backlight assembly of claim 14, wherein the lamp unit includes a first lamp having an L shape by integrally forming the first and second light generating portions and a second lamp having the L shape by integrally forming the third and fourth light generating portions.

16. The backlight assembly of claim 15, wherein the first lamp further comprises a first high-voltage power supply line electrically connected to a high-voltage electrode of the first lamp, for supplying a high voltage from outside to the first lamp and a first low-voltage power supply line electrically connected to a low-voltage electrode of the first lamp, for supplying a low voltage from outside to the first lamp, and the second lamp further comprises a second high-voltage power supply line electrically connected to a high-voltage electrode of the second lamp, for supplying the high voltage from outside to the second lamp and a second low-voltage power supply line electrically connected to a low-voltage electrode of the second lamp, for supplying a low voltage from outside to the second lamp.

17. The backlight assembly of claim 16, wherein a first guide groove is formed at a first sidewall of the receiving unit adjacent to the first and second light generating portions so as to guide the first low-voltage power supply line toward the first high-voltage power supply line, and a second guide groove is formed at a second sidewall of the receiving unit adjacent to the third and fourth light generating portions so as to guide the second low-voltage power supply line toward the second high-voltage power supply line.

18. The backlight assembly of claim 16, wherein the first and second high-voltage power supply lines are adjacently located on a first corner portion among corner portions of the receiving unit.

19. The backlight assembly of claim 18, wherein the first and second low-voltage power supply lines are adjacently located on a second corner portion among the corner portions of the receiving unit, the second corner portion being positioned in a diagonal direction of the first corner portion.

20. The backlight assembly of claim 16, further comprising:
a first lamp holder for capping a first end of the first lamp to prevent the first high-voltage power supply line from being damaged;
a second lamp holder for capping a second end of the first lamp to prevent the first low-voltage power supply line from being damaged; and
a third lamp holder for enclosing a bending portion of the first lamp to prevent the first lamp having the L shape from being damaged.

21. The backlight assembly of claim 16, further comprising:
a first lamp holder for capping a first end of the second lamp to prevent the second high-voltage power supply line from being damaged;
a second lamp holder for capping a second end of the second lamp to prevent the second low-voltage power supply line from being damaged; and
a third lamp holder for enclosing a bending portion of the second lamp to prevent the second lamp having the L shape from being damaged.

22. The backlight assembly of claim 14, wherein the lamp unit is formed in a square shape having the first, the second, the third and the fourth light generating portions integrally formed with each other.

23. The backlight assembly of claim 22, further comprising a first power supply line electrically connected to a first end of the lamp unit having the square shape, for supplying a low voltage to the lamp unit through the first end and a second power supply line electrically connected to a second end of the lamp unit having the square shape, for supplying a high voltage to the lamp unit through the second end, the first and second ends are adjacently located on a first corner among corners of the receiving unit.

24. The backlight assembly of claim 24, further comprising:
a first lamp holder for capping the first end of the lamp having the square shape so as to prevent the first power supply line from being damaged;
a second lamp holder for capping the second end of the lamp having the square shape so as to prevent the second power supply line from being damaged; and
a third lamp holder for respectively enclosing bending portions of the lamp having the square shape so as to prevent the lamp from being damaged.

25. A liquid crystal display apparatus comprising:
a lamp unit for generating a light;
a light guiding plate having a projecting portion for projecting the light, a reflecting portion for reflecting the light to the projecting portion and a side portion which connects the projecting portion with the reflecting portion and receives the light, for guiding the light;
a mold frame having a sidewall of which a central portion is opened by a predetermined size and a bottom prolonged from the sidewall, for receiving the lamp unit and the light guiding unit,
a reflecting sheet disposed under the light guiding plate and having at least one first guide hole formed at one end, for reflecting the light leaked from the light guiding plate;
a bottom chassis having at least one second guide hole and combined with the mold frame so as to prevent the lamp unit, the light guiding plate and the reflecting sheet from being deviated from the mold frame;
an optical sheet disposed on the light guiding plate, for adjusting brightness of the light emitted from the light guiding plate;
a display unit disposed on the optical sheet, for receiving the light from the optical sheet and displaying an image; and
a top chassis combined with the bottom chassis so as to fix the display unit to the mold frame,
wherein the lamp unit is disposed between the light guiding plate and the sidewall of the mold frame to surround the side portion of the light guiding plate.

26. The liquid crystal display apparatus of claim 25, wherein the mold frame further comprises protruding portions respectively formed at corners of the bottom thereof so as to prevent the lamp unit from being deviated from the mold frame, the protruding portions being separated from the sidewall of the mold frame by a predetermined interval.

27. The liquid crystal display apparatus of claim 26, wherein the light guiding plate further comprises clamping portions formed therein by cutting off the light guiding plate, each of the clamping portions being corresponded to the protruding portions.

28. The liquid crystal display apparatus of claim 28, wherein the protruding portions are combined with the clamping portions so as to prevent the light guiding plate from being moved to the lamp unit.

29. The liquid crystal display apparatus of claim 25, wherein the mold frame further comprises at least one first guide boss formed on the sidewall thereof and combined with the first guide hole to guide the reflecting sheet to a position where the reflecting sheet is installed.

30. The liquid crystal display apparatus of claim 25, wherein the mold frame further comprises at least one second guide boss respectively formed on upper surfaces of the protruding portions and combined with the second guide hole formed in the bottom chassis to guide the bottom chassis to a location where the bottom chassis is combined with the mold frame.

31. The liquid crystal display apparatus of claim 25, wherein at least one third guide hole is formed in a first end and a second end opposite to the first end of the optical sheet, respectively.

32. The liquid crystal display apparatus of claim 31, wherein the mold frame further comprises at least one third guide boss formed at the bottom thereof and combined with the third guide hole to prevent the optical sheet from being moved.

33. The liquid crystal display apparatus of claim 25, wherein the optical sheet further comprises wing portions respectively prolonged from the first and second ends of the optical sheet.

34. The liquid crystal display apparatus of claim 33, wherein fixing grooves are formed in the mold frame by cutting off the bottom of the mold frame, the fixing grooves being received the wing portions of the optical sheet to prevent the optical sheet from being moved.

35. The liquid crystal display apparatus of claim 25, further comprising a reflecting plate installed on the bottom of the mold frame and an outer of the lamp unit, for reflecting the light from the lamp unit to the light guiding plate.

36. The liquid crystal display apparatus of claim 25, wherein the lamp unit includes a first L-shaped lamp having a first light generating portion enclosing a first end of the light guiding plate and a second light generating portion enclosing a second end adjacent to the first end; and a second L-shaped lamp having a third light generating portion enclosing a third end opposite to the first end of the light guiding plate and a fourth light generating portion enclosing a fourth end opposite to the second end and adjacent to the third end.

37. The liquid crystal display apparatus of claim 36, wherein the first and second light generating portions are integrally formed and the third and fourth light generating portions are integrally formed, respectively.

38. The liquid crystal display apparatus of claim 38, further comprising:
a first high-voltage power supply line electrically connected to a high-voltage electrode of the first L-shaped lamp, for supplying a high voltage thereto;
a first low-voltage power supply line electrically connected to a low-voltage electrode of the first L-shaped lamp, for supplying a low voltage thereto;
a first lamp holder for capping a first end of the first L-shaped lamp so as to prevent the first high-voltage power supply line from being damaged;
a second lamp holder for capping a second end of the first L-shaped lamp so as to prevent the first low-voltage power supply line from being damaged; and
a third lamp holder for enclosing a bending portion of the first L-shaped lamp so as to prevent the first L-shaped lamp from being damaged.

39. The liquid crystal display apparatus of claim 38, further comprising:
a second high-voltage power supply line electrically connected to a high-voltage electrode of the second L-shaped lamp, for supplying a high voltage thereto;
a second low-voltage power supply line electrically connected to a low-voltage electrode of the second L-shaped lamp, for supplying a low voltage thereto;
a first lamp holder for capping a first end of the second L-shaped lamp so as to prevent the second high-voltage power supply line from being damaged;
a second lamp holder for capping a second end of the second L-shaped lamp so as to prevent the second low-voltage power supply line from being damaged; and
a third lamp holder for enclosing a bending portion of the second L-shaped lamp so as to prevent the second L-shaped lamp from being damaged.

40. The liquid crystal display apparatus of claim 39, wherein a first guide groove is formed at a first sidewall of the mold frame adjacent to the first and second light generating portions so as to guide the first low-voltage power supply line to the first high-voltage power supply line, and a second guide groove is formed at a second sidewall of the mold frame adjacent to the third and fourth light generating portions so as to guide the second low-voltage power supply line to the second high-voltage power supply line.

41. The liquid crystal display apparatus of claim 25, wherein the lamp unit is formed in a square shape having a first light generating portion which covers a first side portion of the light guiding plate, a second light generating portion which covers a second side portion adjacent to the first side portion, a third light generating portion which covers a third side portion opposite to the first side portion and a fourth light generating portion which covers a fourth side portion opposite to the second side portion and adjacent to the third side portion, and the first, second, third and fourth light generating portions being integrally formed with each other.

42. The liquid crystal display apparatus of claim 41, further comprising a first power supply line electrically connected to a first end of the lamp having the square shape, for supplying a low voltage thereto; and a second power supply line electrically connected to a second end of the lamp having the square shape, for supplying a high voltage thereto, the first and second ends are adjacently located on a first corner among corners of the mold frame.

43. The liquid crystal display apparatus of claim 42, further comprising:
a first lamp holder for capping the first end of the lamp having the square shape so as to prevent the first power supply line from being damaged;
a second lamp holder for capping the second end of the lamp having the square shape so as to prevent the second power supply line from being damaged; and
a third lamp holder for respectively enclosing bending portions of the lamp having the square shape so as to prevent the lamp from being damaged.
